(19) United States
(12) Patent Application Publication
(10) Pub. No.: US 2010/0049499 A1
(43) Pub. Date: Feb. 25, 2010

(54) DOCUMENT ANALYZING APPARATUS AND METHOD THEREOF

(76) Inventor: Haruo Hayashi, Uji-shi (JP)

Correspondence Address: DARBY & DARBY P.C., P.O. BOX 770, Church Street Station, New York, NY, 10008-0770, US

(21) Appl. No.: 12/515,604

(22) PCT Filed: Nov. 22, 2007
(86) PCT No.: PCT/JP2007/073257

§ 371 Date: May 20, 2009

(30) Foreign Application Priority Data
Nov. 22, 2006 (JP) 2006-315238

(51) Int. Cl. G06F 17/27

(52) U.S. Cl. 704/9

(57) ABSTRACT

In a document analyzing apparatus (10), a computer (14) successively produces a text corpus Ct from a linguistic material which increases in time series in a step S3, segments the text data into morphemes to which information of parts-of-speech is added in a step S5, removes unnecessary morphemes based on the parts-of-speech information in a step S7, and calculates a chronological incremental TFIDF as to each morpheme in a step S11. In a step S13, a cumulative total value (Σ TF) of the TF and a cumulative total value (Σ chronological incremental TFIDF) of the chronological incremental TFIDF prior to that corpus are calculated, and in a step S17, a residual analysis of the Σ chronological incremental TFIDF (actual measurement) in that corpus is performed with a regression curve which has been produced in the previous corpus. A morpheme having a large positive residual is selected as a unique term while a morpheme having a small residual value (negative) is selected as a ubiquitous term.

### TECHNICAL FIELD

The present invention relates to a document analyzing apparatus and a method thereof. More specifically, the present invention relates to a novel document analyzing apparatus and its method capable of extracting or detecting a unique term (keyword) according to a chronological order from a linguistic material which increases in time series, such as news, web news, web logs, a newspaper, a magazine, an interview record, a deposition, a questionnaire, a novel, etc.

### PRIOR ART

The world of disaster management is an academic field being in need of cooperation with a number of academic fields, and is a practical field being in need of cooperation between practionners and researchers. This means that it is difficult to be well versed in an entire world surrounding the disaster management.

Not only understanding of the information in relation to such a disaster management is hampered by lack of knowledge for the respective fields, but also because the information are collected, saved and summarized by a technique on a discipline basis, data and research products having formats each of which conforms to search of the respective disciplines are often hard to use and hard to understand. In the world of the disaster management, this makes it difficult to make a communication between researchers who are different in disciplines, and between practionners and researchers of the disaster management.

From this background, in the world of the disaster management, with the goal of making easy exchanges of information between the practionners and the researchers, prompting a cross-disciplinary study and spreading a research product to a practical area, a need f is heightened for constructing the basis of the research support and the practical support capable of searching data and information, and a research product in relation to the disaster management of a self field to be used by researchers and practionners in other fields without any constraints due to the kind of the medium no matter when or where by using a user-friendly interface.

An inventor, et al. had tried to develop an inclusive database (Cross Media Database, hereinafter referred to as “XMDB”.) including a search/display function for sharing or exchanging information between disaster management researchers and disaster management practitioners (Nonpatent Document 1: Nozomu Yositomi, Go Urakawa, Ayumu Simoda, Hironori Kawakata, Haruo Hayasi, “Construction of cross media database for sharing disaster management information” Journal of Institute of Social Safety Science, No. 6, pp. 315-322, 2004).

The data and information to be accumulated in the XMDB are not restricted to the data and information in relation to natural phenomena, such as an observation result of shakes by a strong-motion seismograph and rainfalls around the nation observed by the Meteorological Agency. For promoting the development of research and spreading the research products and the past teaching to the practical field, data and information in relation to the disaster as a social phenomenon, such as records of experiences, records of addressing the disaster (style and memo), disaster reports, published materials, newspaper articles, web-news articles become the objects of making a database.

In the world of the disaster management, activities for social-scientific study relating to disasters have long been developed (Nonpatent Document 2: Hiroyuki Kameda “Study of integrated disaster management counter measure against urban disasters in the light of the South Hyogo earthquake in 1995” urgent projects of the Ministry of Education, Culture, Sports, Science and Technology, 37 pp. 1995).

As a study of disasters, in addition to a natural-scientific study applying a mechanics covering a disaster as a natural phenomena, a study considering phases as a society including victims of a disaster who experience the disaster, workers for addressing a disaster, persons outside a disaster area, and a social phenomenon for dealing problem of the reconstruction from a disaster has often been tackled with the occurrence of the Great Hanshin Awaji Earthquake in 1995 and the 9.11 terrorist attacks in 2001 as a turning point. The study treating with the social phenomenon needs to make a database of records of the condition of the disaster as well as the framework of the natural science.

In the natural disaster science, various analyses are performed based on observation results of the shakes of the strong-motion seismograph and observation results of the movements of clouds by a weather satellite, to thereby deepen the understanding the generation process of a hazard of nature such as the earthquake and heavy rain, or to allow a study of the improvement of resistance of the structure by using these results as inputs and external forces of a simulation.

In the filed dealing with the social phenomenon, similar to the approach of the natural disaster science aimed at the understanding of the natural phenomena and improvement of the resilience of the structure, it is required to prepare things for compiling data and materials to a database to thereby extract and systematize teachings and knowledge, and implement an effective response to disasters. Furthermore, various records in relation to the past responses to the disasters in addition to the study are located as important intelligence information that practionners go through.

However, the records of the social phenomenon under the disasters in relation to the social phenomenon cause following problems due to their data format as linguistic materials (text materials) when being accumulated in the XMDB and being performed with information retrieval.

The first problem is that at a time of accumulation to the database, for applying keywords representing contents of respective records, a large number of human resources and specialized knowledge are required. The XMDB mounts a function of information retrieval based on the time, space, theme, and therefore, as data to be accumulated, three kinds of meta data, such as chronological information like created date and time of data, position information induced in the data, and a keyword representative of the content of the data are required to be applied to a record.

Applying such meta data is placed as an important procedure in the scene of the intelligence as well, and becomes an indispensable procedure for managing intelligence information, or analyzing a trend (Nonpatent Document 3: Tutomu Matumura “operational intelligence—tactic information theory for decision” Nihon Keizai Shimbun, Inc., 220 pp. 2006).

For the task of applying the keywords representative of the contents of the data, human resources having inclusive understandings as to the disaster management field are required. However, there is not such a person in reality, and reading one by one large amounts of data generated from the various source of the information and then applying keywords by a person taking the occurrence of the disaster this opportunity is substantially impossible, and in addition thereto, arbitrariness (subjective sensation) by the person is necessarily interposed.

The second problem is with which keyword the information retrieval has to be performed. One who has inclusive understandings about the world of the disaster management or is familiar with the individual cases of the disasters would easily imagine keywords required for information retrieval based on the existing knowledge. However, it is natural that it is difficult for practionners who do not have a specialized knowledge to imagine an appropriate search keyword, and researchers themselves also only have knowledge about the theme biased to the respective research fields, and are not familiar with all the cases of the disaster.

On the other hand, a method of extracting keywords from the document data is proposed in a Patent Document 1 (Japanese Patent Application Laid-Open No. 2004-5711 [G06F 17/30]), etc.

The keyword extracting device and its method in the Patent Document 1 is aimed at a fixedly-determined amount of documents, and thus cannot effectively deal with a text data cluster having a characteristic of having an order in time series, or increasing the information amount in time series such as news, for example.

### SUMMARY OF THE INVENTION

Therefore, it is a primary object of the present invention to provide novel document analyzing apparatus and a method thereof.

Another object of the present invention is to provide a document analyzing apparatus and a method thereof capable of detecting appropriate unique terms (keywords) and appropriate ubiquitous terms from a linguistic material which increases in time series.

The present invention employs following features in order to solve the above-described problems. It should be noted that reference numerals and the supplements inside the parentheses show one example of a corresponding relationship with the embodiments described later for easy understanding of the present invention, and do not limit the present invention.

A first invention is a document analyzing apparatus analyzing a linguistic material which increases in time series, comprises: a text corpus producer for producing a text corpus including text data of unit documents having a chronological order, and in which unit documents later in the chronological order are larger in number than unit documents earlier in the chronological order; a morpheme analyzer for adding parts-of-speech information to morphemes making up of the text data included in the corpus text; an unnecessary morpheme remover for removing an unnecessary morpheme from the text data on the basis of the parts-of-speech information; a calculator for calculating, with respect to a morpheme which is not removed by the unnecessary morpheme remover, a chronological incremental TFIDF for each morpheme to obtain an actual measurement of the chronological incremental TFIDF; and a residual analyzer for evaluating a residual value for each morpheme by performing a residual analysis between the actual measurement calculated by the calculator and an estimate value of a cumulative total value of the chronological incremental TFIDF estimated in a previous corpus.

In the first invention, a document analyzing apparatus is typically constituted of a computer. The text corpus producer (S3: a reference numeral illustratively showing a corresponding part in embodiments, and this holds true the following.) makes a current corpus including unit documents being larger in number than those of a corpus earlier in chronological order when a preset time elapses. In a case of the web news successively increasing with time, for example, as a set time (set time is arbitrary) elapses, by using the text data of the web news, a corpus text is produced, but as a linguistic material, there are not only documents successively increasing but also documents having a merely chronological order. In the latter case, a corpus producer may not sequentially produce a corpus text with the course of time, but may prepare or produce a plurality of corpuses being successive in chronological order at once.

The morpheme analyzer (S5), in a case of the text data having a language system in which segmentation to morphemes is not performed like Japanese language, by utilizing a morpheme analyzing tool, such as Chasen (http://chasen.naist.jp/hiki/ChaSen/), for example, the text data of the unit document included in the corpus is segmented to morphemes, to each of which parts-of-speech information is added. However, in a case of the language system in which morphemes in the text have already been segmented like English language, for example, a task of segmenting to morphemes is not required and therefore, in the morpheme analyzer, tagging processing is performed, for example, to add words-of-speech information to respective morphemes making up of the text.

An unnecessary morpheme remover (S7) removes a morpheme having a kind of parts-of-speech that is set in advance as an unnecessary morpheme on the basis of the above-described parts-of-speech information added to each of the morphemes. That is, at a time of the morphological analysis, it is selected whether or not the morpheme is adopted as a candidate of a unique term and /or a ubiquitous term on the basis of the parts-of-speech information added to each of the morphemes. Here, the kind of the parts-of-speech which makes a morpheme unnecessary can be arbitrarily set.

A calculator (S11) calculates a TF (Term Frequency), that is, a frequency of appearance (total number) of a keyword candidate in the unit document with respect to each of the morphemes remained in the corpus, and moreover calculates an IDF (Inversed Document Frequency) taking a parameter of the time into account, that is, an originality value that is a value indicating that the morpheme does not appear in other documents, to thereby calculate a chronological incremental TFIDF (Term Frequency Inversed Document Frequency) of that morpheme in the corpus as “TF”×“IDF”.

A residual analyzer (S17) performs a residual analysis between an estimate value of the cumulative total value of the chronological incremental TFIDF of the relevant morpheme estimated in a corpus earlier in the chronological order and the actual measurement of the cumulative total value calculated by the calculator, to thereby evaluate a residual value (positive, negative) of that morpheme.

According to the first invention, even if the linguistic material is a type of increasing in time series, the corpus producer produces a text corpus including unit documents in which unit documents later in the chronological order are larger in number than unit documents earlier in the chronological order, and a regression curve that renders the cumulative total value of the chronological incremental TFIDF as a response and the cumulative total value of the TF as an explanatory variable is produced on the basis of the corpuses, and therefore, a flow of the processing in which assuming that indexes of the cumulative total value of the chronological incremental TFIDF of the current corpus are distributed on the regression curve produced in the previous corpus, and the estimate value of the cumulative total value of the chronological incremental TFIDF of the current corpus taking the cumulative total value of the TF of the current corpus as an input is obtained, allows the linguistic material to be surely analyzed.

A second invention is according to the first invention, and further comprises a regression curve producer for producing a regression curve in each corpus between a cumulative total value of a chronological incremental TFIDF prior to the corpus and a cumulative total value of a TF prior to the corpus, wherein the residual analyzer performs a residual analysis between a regression curve produced by the regression curve producer in a previous corpus and an actual measurement of the chronological incremental TFIDF of each morpheme calculated by the calculator in a current corpus.

In the second invention, the regression curve producer calculates a constant by taking a cumulative total value(ΣTF) of the TF being an explanatory variable as X, and taking the cumulative total value (Σ chronological incremental TFIDF) of a chronological incremental TFIDF being a dependent variable as Y to thereby produce a regression curve. Here, the calculation of such regression curve is to be made in advance in the corpus earlier in chronological order. According to the second invention, in the corpus earlier in chronological order, a regression curve for estimating or anticipating the cumulative total value of the chronological incremental TFIDF in the corpus later in chronological order is prepared, capable of performing the residual analysis in the later corpus quickly.

A third invention is according to the first or second invention, further comprises a unique term selector for selecting a morpheme for which a positive residual value can be obtained as a result of the residual analysis by the residual analyzer as a unique term in the corpus.

In the third invention, a unique term selector (S21, S21A, S21B) selects a morpheme having a positive residual value (larger value) as a unique term. According to the third invention, only the residual value is selected as a parameter, and therefore, it is possible to select a unique term being objective. The unique term functions as a keyword indicating the characteristic of the corpus.

A fourth invention is according to the third invention, and the unique term selector includes a filterer for performing filtering processing.

In the fourth invention, in a case that a user selectively sets a filtering as an option, a computer (14) executes a filtering 1 for removing a term (morpheme) about which the number of documents the term appears is once during Δt (1) and/or a filtering 2 for removing a morpheme with a high frequency of appearance from the relationship between the number of documents the term appears and the frequency of appearance of the term (morpheme) (2), for example. This makes it possible to remove a morpheme representing an extremely high discriminating value.

A fifth invention is according to the third or fourth invention, further comprises a unique term outputter for visually outputting the unique term selected by the unique term selector.

In the fifth invention, the computer (14) visually displays (outputs) in graph form the unique term selected by the unique term selectors as shown in FIG. 15-FIG. 21 and FIG. 27-FIG. 29.

A sixth invention is according to any one of the first to fifth inventions, and further comprises a ubiquitous term selector for selecting a morpheme for which a negative residual value can be obtained as a result of the residual analysis by the residual analyzer as a ubiquitous term of the corpus.

In the sixth invention, the ubiquitous term selector (S21) selects a morpheme having a negative residual value (larger value) as a ubiquitous term. According to the sixth invention, only the residual value is selected as a parameter, and therefore, it is possible to select a ubiquitous term being objective. The ubiquitous term functions as an index for grouping other corpuses as well as this corpus.

A seventh invention is according to the sixth invention, and further comprises a ubiquitous term outputter for visually outputting the ubiquitous term selected by the ubiquitous term selector.

In the seventh invention, the computer (14) visually displays (outputs) the ubiquitous term selected by the ubiquitous term selector as shown in FIG. 15-FIG. 21, for example.

An eighth invention is according to the fifth invention, and further comprises a document outputter for visually outputting, with respect to at least one of the unique terms output by the unique term outputter, a unit document including the unique term.

In the eighth invention, on the basis of a discriminating value (DVti) list of the morpheme (ti) produced in each time point, for example, a sum of the discriminating values with respect to unique terms (top ten words with a high discriminating value) is evaluated for each unit document included in the current corpus. At least one unit document (document) is selected as a “noticeable article” being higher in the sum of the discriminating values (RV), for example, and the selected unit document is read from the text data table (20), for example, to display at least a headline thereof together with the unique term. According to the eighth invention, at least the headline of the unit document (article) including the term (morpheme) higher in the sum of the discriminating values is displayed along with the content as necessary. This makes it possible to complement the information of a context of the morpheme lost in the analysis, and this makes it easy to understand and interpret the morpheme representing a high peculiarity.

A ninth invention is a document analyzing program for analyzing a linguistic material which increases in time series, and causes a computer to function as a corpus text producing means for producing a corpus text including text data of unit documents having a chronological order, and in which unit documents later in the chronological order are larger in number than unit documents earlier in the chronological order; a morpheme analyzing means for adding parts-of-speech information to morphemes making up of the text data included in the corpus text; an unnecessary morpheme removing means for removing an unnecessary morpheme from the text data on the basis of the parts-of-speech information; a calculating means for calculating, with respect to the morphemes which are not removed by the unnecessary morpheme removing means, a chronological incremental TFIDF for each morpheme and each unit document to obtain an actual measurement of the chronological incremental TFIDF; and a residual analyzing means for evaluating a residual value for each morpheme by performing a residual analysis between the actual measurement calculated by the calculating means and an estimate value of the cumulative total value of the chronological incremental TFIDF estimated in the previous corpus.

A tenth invention is a document analyzing method for analyzing a linguistic material which increases in time series, including steps of: a text corpus producing step for producing a text corpus including text data of unit documents having a chronological order and in which unit documents later in the chronological order are larger in number than unit documents earlier in the chronological order; a morpheme analyzing step for adding parts-of-speech information to morphemes making up of the text data included in the text corpus; an unnecessary morpheme removing step for removing an unnecessary morpheme from the text data on the basis of the parts-of-speech information; a calculating step for calculating, with respect to the morphemes which are not removed by the unnecessary morpheme removing step, a chronological incremental TFIDF for each morpheme to obtain an actual measurement of the chronological incremental TFIDF; and

a residual analyzing step for evaluating a residual value for each morpheme by performing a residual analysis between the actual measurement calculated by the calculating step and an estimate value of the cumulative total value of the chronological incremental TFIDF estimated in the previous corpus.

The ninth invention and the tenth invention are basically similar to the first invention.

According to the present invention, in accordance with the increase of the linguistic material, a corpus in which the number of unit documents is increased in chronological order is produced, and therefore, even the linguistic material, which increases in time series, can be surely analyzed or construed, so that a unique term, a ubiquitous term and etc. can be extracted therefrom.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a keyword detecting system of one embodiment of the present invention.

FIG. 2 is an illustrative view showing one example of a text data table used in this embodiment.

FIG. 3 is a flowchart showing an operation of a computer in FIG. 1 embodiment.

FIG. 4 is an illustrative view showing one example of a corpus which is produced in this embodiment and increases with time.

FIG. 5 is a table showing one example of an analysis result of a frequency of appearance of each article and morpheme.

FIG. 6 is a table showing the number of unit documents N as to each article and morpheme, FIG. 6(A) is a general case that an amount of the linguistic material is constant (never increase with time), FIG. 6(B) shows a case of the embodiment that a linguistic material which increases in time series is analyzed. FIG. 6(A) shows the number of unit documents N for each morpheme (t1, t2, t3 . . . ) being a display example in order to unify the notation with other drawings (FIG. 5-8).

FIG. 7 is a table representing a DF as to each article and morpheme, FIG. 7(A) is a general case that an amount of the linguistic material is constant (never increase with time), and FIG. 7(B) shows a case of the embodiment that a linguistic material which increase in time series is analyzed.

FIG. 8 is a table showing an TFIDF (A) and a chronological incremental TFIDF (B) as to each article and morpheme, FIG. 8(A) shows a general case that an amount of the linguistic material is constant (never increase with time), and FIG. 8(B) shows a case of the embodiment that a linguistic material which increase in time series is analyzed.

FIG. 9 is an illustrative view showing one example of a regression curve.

FIG. 10 is a graph representing a regression curve and residuals (positive and negative), and the abscissa is the sum of the TF, and the ordinate is the sum of the chronological incremental TFIDF.

FIG. 11 is an illustrative view showing one display example to be displayed by the computer of FIG. 1 embodiment.

FIG. 12 is an illustrative view showing another display example to be displayed by the computer of FIG. 1 embodiment.

FIG. 13 is a graph showing a regression curve for each corpus similar to FIG. 9, FIG. 13(A) shows the regression curve in the corpus 10 hours after the occurrence of the disaster, FIG. 13(B) shows the regression curve in the corpus 100 hours after the occurrence of the disaster, FIG. 13(C) shows the regression curve in the corpus 1000 hours after the occurrence of the disaster, and FIG. 13(D) shows the regression curve in the corpus 4500 hours after the occurrence of the disaster.

FIG. 14 is an illustrative view showing a relationship between the corpus and the regression curve.

FIG. 15 is an illustrative view showing the feature amounts (the upper side is positive, and the lower side is negative) within 10 hours after the occurrence of the disaster which is evaluated from an actual web news by utilizing FIG. 1 embodiment.

FIG. 16 is an illustrative view showing a feature amount within 10-100 hours after the occurrence of the disaster which is evaluated in a manner similar to FIG. 15.

FIG. 17 is an illustrative view showing a feature amount within 100-500 hours after the occurrence of the disaster which is evaluated in a manner similar to FIG. 15.

FIG. 18 is an illustrative view showing a feature amount within 500-1000 hours after the occurrence of the disaster which is evaluated in a manner similar to FIG. 15.

FIG. 19 is an illustrative view showing a feature amount within 1000-2000 hours after the occurrence of the disaster which is evaluated in a manner similar to FIG. 15.

FIG. 20 is an illustrative view showing a feature amount within 2000-3000 hours after the occurrence of the disaster which is evaluated in a manner similar to FIG. 15.

FIG. 21 is an illustrative view showing a feature amount within 3000-4500 hours after the occurrence of the disaster which is evaluated in a manner similar to FIG. 15.

FIG. 22 is an illustrative view showing a change of keywords extracted from actual web news by utilizing FIG. 1 embodiment.

FIG. 23 is a flowchart showing an operation of the computer in FIG. 1 in other embodiment of this invention.

FIG. 24 is an illustrative view showing frequency of appearance TF and the number of documents in which the term appears DF of each term which are to be stored in a memory in the other embodiment.

FIG. 25 is a graph showing one example of a regression line and 95% confidence limits in the other embodiment.

FIG. 26 is a graph showing another example of a regression line and 95% confidence limits in the other embodiment.

FIG. 27 is an illustrative view showing a graph display of unique terms in a case that a filtering option is not selected.

FIG. 28 is an illustrative view showing a graph display of unique terms in a case that a filtering 1 is selected as an option.

FIG. 29 is an illustrative view showing a graph display of unique terms in a case that a filtering 2 is selected as an option.

### BEST MODE FOR PRACTICING THE INVENTION

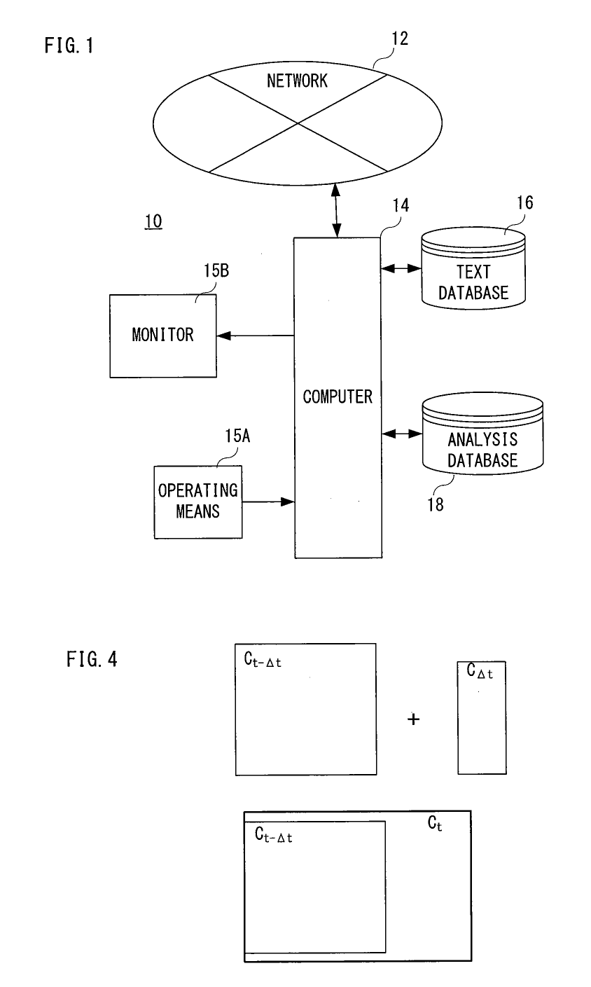

A document analyzing apparatus 10 of one embodiment according to this invention shown in FIG. 1 includes a computer 14 to be connected to a communication network (network) 12, such as the Internet with wire or wirelessly. The computer 14 is basically provided with an operating means 15A, such as a keyboard, a mouse and a monitor 15B, such as a liquid crystal display, and the computer 14 is further provided with a text database 16 and an analysis database 18 adjunctively. The computer 14 has naturally an internal memory, and the internal memory (not shown) is utilized as a working memory, etc., and temporarily stores result data obtained by calculation, analysis result data, various data during analyzing.

The text database 16 successively stores text data of web news in time series, acquired by the computer 14 over the network 12, and the computer 14 sequentially analyzes or construes the text data of the web news to thereby extract unique terms (keywords) which change in time series.

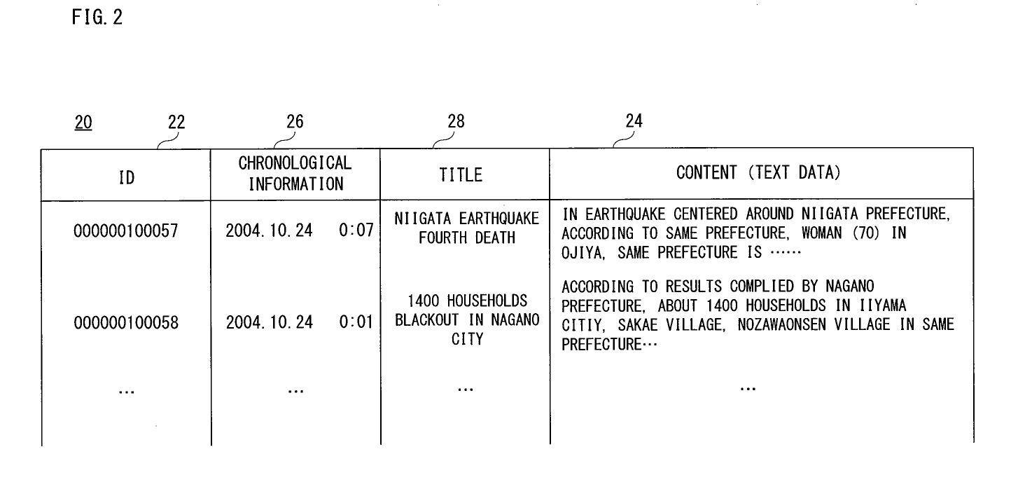

FIG. 2 shows one example of a text data table 20 accumulated in the text database 16. The text data table 20 is specifically a table having text data of a “unit document” as one record of an arbitrary size from a linguistic material being made up of text data.

As an example of the unit document, in a case of the web news, articles within a predetermined time period, articles within one day, one article, one paragraph, one sentence, and etc. are cited. When a newspaper is taken as an example, one newspaper, one article, one paragraph, one sentence, and etc. are cited. In a case of a literary work (novel) or the like, there are one work, one chapter, one paragraph, one sentence, and etc.

Besides, in a case that a weblog on the web is an object to be analyzed, diary of one day may be taken as a unit document, and one inquiry, a complaint, etc. to a call center may be taken as a unit document. An arbitrary unit is defined as a “unit document” with respect to the linguistic material to thereby produce the database 20.

As shown in FIG. 2, with respect to one record, chronological information (time stamp) 26 is given as meta data in addition to an identifier (ID number) 22 which is formed by numerals, alphabet, etc. and text data 24. As for the chronological information 26, a transmission date and time in a case of the web-news article are applicable, and an inquiry time is also applicable in a case of an inquiry to the call center. The document analyzing apparatus 10 in this embodiment is intended for language information in which the number of characters increases with time, such as news and weblogs, etc. However, even the linguistic material which is not updated constantly, such as literary works, since the linguistic material has a linearly-extendability, allows a reader of the linguistic material to understand language information with the course of time. Accordingly, with respect to the linguistic material which is static at a glance and does not have chronological information, such as novels and literary works, order information (chapter 1, chapter 2 . . . , first paragraph, second paragraph . . . , first sentence, second sentence . . . etc.) is applied to the fields of the chronological information 26 shown in FIG. 2 as meta data in place of the chronological information. Besides, an arbitrary field, such as a title 26 is provided as necessary to thereby produce the database table 20.

When the text data table 20 is produced by the computer 14, the text data table can be produced from web news acquired over the network 12, for example, by utilizing an application installed on the computer 14, such as DBMS (Data Base Management System).

Additionally, data including text data 24 (FIG. 2) of one unit document which is discriminated by one identifying symbol (ID) 22 shown in FIG. 2 and applied with the time-series information 26 is called one record. The linguistic material body (corpus) means a set of such records.

In the embodiment described later, some pieces of web news are tried to be used as a linguistic material body increasing in time series from which a keyword (unique term) is to be detected. However, as other linguistic materials of such a kind, data including an arbitrary time-dependency, such as a newspaper, a magazine, a weblog, an interview record, a deposition, a questionnaire, a novel, etc. can be assumed.

The analysis database 18 stores in advance all dictionaries and grammatical rules necessary for the keyword detection in this embodiment, such as a parts-of-speech dictionary for a morpheme analysis to be described later, etc., and accumulates results of the analysis. Here, this analysis database 18 may be made up of the internal memory of the computer 14 as well as the above-described text database 16.

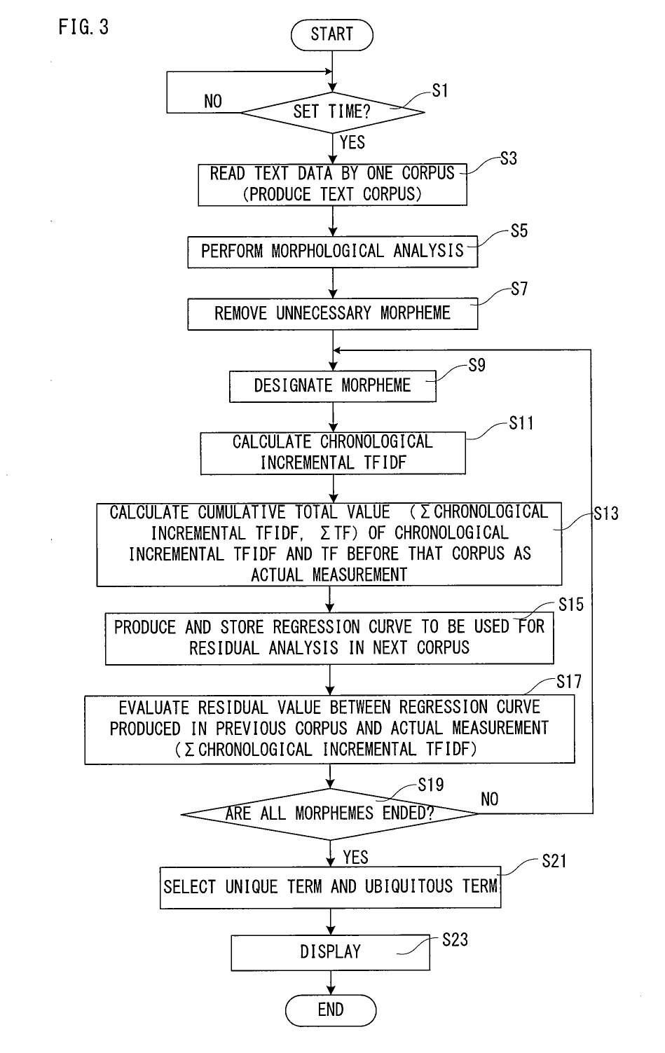

The computer 14 extracts or detects a keyword according to a keyword extracting program as shown in FIG. 3.

Referring to FIG. 3, in a first step S1, the computer 14 determines whether or not a set time elapses. The “set time” is a sectioning time period (Δt) for demarcating respective corpuses having an chronological order from the linguistic material which increases in time series. This “set time” can be freely set by a user. For example, when a linguistic material about which changes in condition occurs at short times is analyzed, a short set time (Δt) may be set, and in a reverse case of a linguistic material, the set time Δt may be set long. As an example of the Δt, 1 hour, 10 hours, 100 hours, 1 day, 1 week, 1 month, etc. can be mentioned. In addition, it is also conceivable that this Δt may change as time advances. As one example, the Δt is set to “1 hour” before 24 hours elapse from the occurrence of a disaster, the Δt is set to “10 hours” before 3 days elapse thereafter, and the Δt is moreover set to “one day” after the lapse of one month from the occurrence of the disaster.

Then, when an arbitrary set time is set by the user, the set time is stored in an appropriate memory area (register) of the computer 14, so that the computer 14 can determine whether or not the time set in the step S1 elapses by comparing the internal clock data with the set time set to the register.

If “YES” is determined in the step S1, the computer 14 next executes corpus producing processing in a step S3 to read the text data of a unit document increased during the set time (Δt) from the text data table 20 shown in FIG. 2, for example, and produce a current text corpus Ct.

The corpus Ct shown in FIG. 4 represents a corpus at a present, but the corpus Ct is a corpus formed later by a set time Δt from a corpus Ct−Δt which is earlier in chronological order than it. That is, the corpus Ct is of summing up the immediately-before corpus Ct−Δt and a corpus CΔt being an increased amount.

Here, the “corpus” is defined as a set of written language for a language analysis, or a set of audio linguistic material, and specifically indicates ones constructed by an electronic text, and generally indicates collected ones of electronic and original text clusters. However, in this embodiment, by interpreting the aforementioned definition broadly, morpheme clusters each having information of a chronological incremental TFIDF and a TF (both are described later) with respect to the original text is called a corpus for convenience. Accordingly, it is to be understood that the text corpus, here, means a linguistic material body including text data of at least one record, that is, at least one unit document.

Succeedingly, in a step S5, the text data 24 (FIG. 2) included in the corpus is segmented to morphemes, to which parts-of-speech information is added. The morphological analysis, here, is a language processing of segmenting a sentence written by the natural language into a row of morphemes (broadly speaking, the smallest unit capable of having a meaning in the language), and identifying the parts-of-speech. As sources of information to be referred, knowledge of the grammar of a target language (a group of grammatical rules) and the dictionary (term list with information, such as a parts-of-speech), but these grammatical rules and dictionary are prepared in the aforementioned analysis database 18.

It should be noted that in this embodiment, free morphological analysis software which is called “Chasen” (http://chasen.naist.jp/hiki/ChaSen/), as one example, is introduced to the computer 14 so as to be used.

Additionally, if the document is Japanese language, in this embodiment, a tool like the aforementioned “Chasen” is used such that the document is first segmented into morphemes to be extracted, and the parts-of-speech is applied to each of the extracted morphemes. However, in the language system such as English language, for example, since segmentation has already been done, morpheme extracting processing is not required, but processing of specifying the parts-of-speech is required, and therefore, tagging (discriminating the parts-of-speech) processing is performed in the step S5.

Furthermore, the morpheme (cluster) and parts-of-speech information analyzed in the step S5 are accumulated in the text database 16.

In a succeeding step S7, the computer 14 executes unnecessary morpheme removing processing in order to remove morphemes with the kind of the parts-of-speech which is set as an unnecessary term on the basis of the above-described parts-of-speech information.

That is, at a time of the morphological analysis, it is determined whether or not the morpheme should be adopted as a keyword candidate on the basis of the “parts-of-speech information” applied to each morpheme. The kind of the parts-of-speech of the morpheme (candidate of a unique term (keyword)/ubiquitous term) set as an unnecessary term is different depending on the parts-of-speech system to be output by the morpheme analyzing system and the intention of the analysis by the user. The kind of the parts-of-speech selected as an unnecessary morpheme can be decided by the user as necessary. In the experiment actually analyzed by the inventor, et al., morphemes in the result of the analysis by means of the “Chasen” which are not independent and do not take a form of suffix other than a noun, a verb, an adverb, and an adjective are rendered as unnecessary morphemes. Here, an unnecessary term removing rule about what kinds of parts-of-speech of the morpheme are to be an unnecessary term may be set in advance in the analysis database 18.

After execution of the step S7, one or more necessary morphemes remain in the corpus accumulated in the text database 16, for example. Accordingly, the processing from steps S9 to S19 is performed on each of the morpheme which are not removed and remain in the corpus. Thus, the computer 14 designates the morpheme to be processed according to the order selected by an appropriate rule in the step S9.

In the next step S11, the computer 14 evaluates the chronological incremental TFIDF with respect to the morpheme designated in the step S9. Here, the “TF” is Term Frequency, that is, a frequency (total number) (frequency of appearance) of the keyword candidate in the unit document, the “IDF” taking a parameter of the time into consideration represents an Inversed Document Frequency (the number of inversed appearing documents), that is, originality representing not appears in other corpuses. Accordingly, the “chronological incremental TFIDF” is “TF”×“IDF”, may be called a Term Frequency Inversed Document Frequency, and sometimes be represented as TF*IDF, but here, it is represented as a chronological incremental TFIDF. The chronological incremental TFIDF indicates an appearance rate of the morpheme, and this is a kind of weighing index.

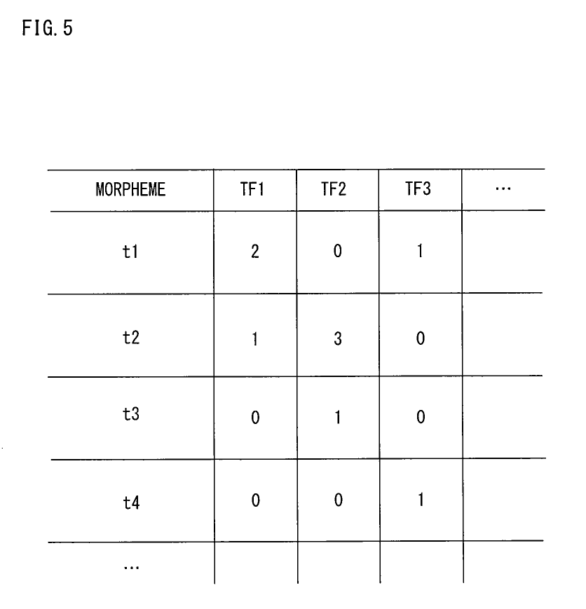

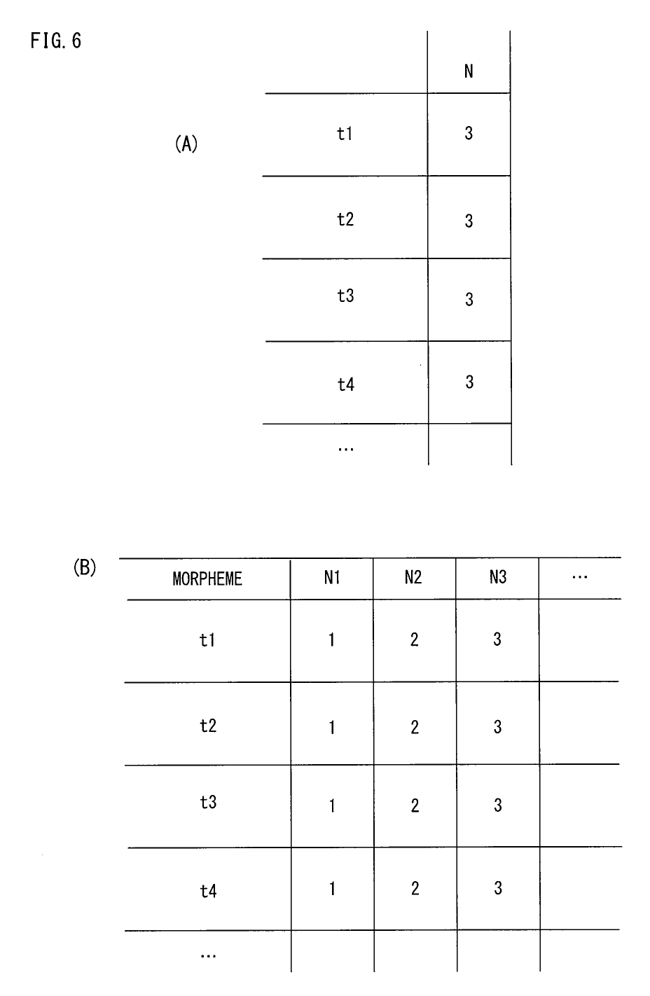

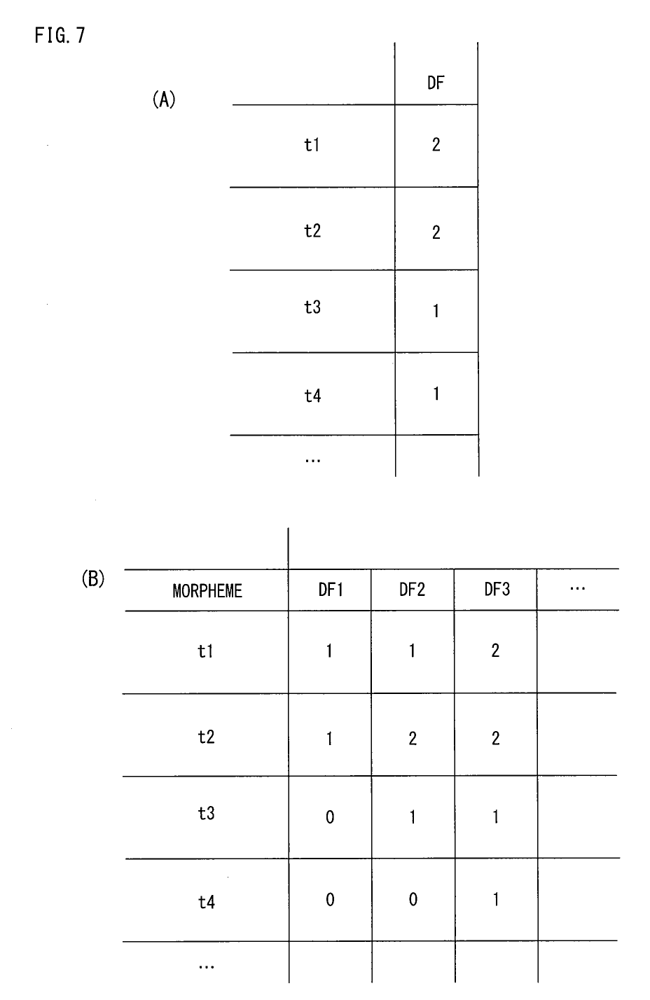

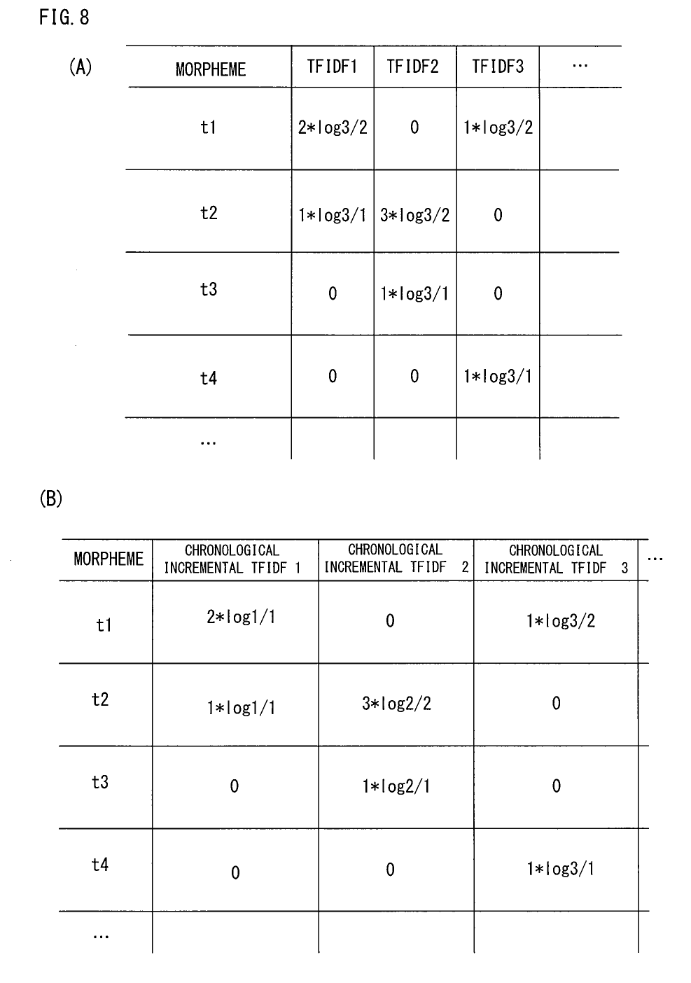

Even if the number of articles is successively changed as shown in FIG. 5, since a general analysis is performed after the constant number N of the unit documents are finally accumulated, the total number N of the unit documents is a constant as shown in FIG. 6(A). Thus, the DF (Document Frequency) of the TFIDF when such general text data is analyzed, the number of documents in which morphemes appear is made constant as shown in FIG. 7(A). Accordingly, the TFIDF in a case of the general analyzing technique is as shown in FIG. 8(A).

On the contrary thereto, one record dealt in the system of this embodiment has the chronological information or the order information 26 (FIG. 2), and therefore, respective records (text data) can be arranged in chronological order or in the order of the order information. Thus, in the DF of the chronological incremental TFIDF at that time, a subscript of j (subscript on the basis of the time and order information) exists. The “j” here indicates an order when records are arranged in chronological order or in the order of order information.

Accordingly, in the document analyzing apparatus 10 in this embodiment, in a case that a TFIDF with respect to a certain article dj is to be evaluated, the TFIDF is successively calculated by utilizing not the total number N of unit documents based on all the articles finally collected and the DF based thereon, but the Nj (the total number of articles before the article dj is transmitted) by taking the time based on the number of articles which has already been transmitted before the article dj into account, and DF (ti, dj) (the number documents in which the morpheme ti appears before the article dj is transmitted). In the document analyzing apparatus 10 of this embodiment, a corpus is set such that the number of unit documents included therein is increased in chronological order as shown in FIG. 4, and by calculating a TFIDF of each morpheme in the corpus, from the text data in a time series (order), unique terms (keywords) and ubiquitous terms according to this order can be extracted or detected.

More specifically, the general TFIDF is calculated in a following equation (1), and the chronological incremental TFIDF defined here is calculated in a following equation (2).

TFIDF(ti, dj)=TF(ti, dj)*IDF(ti)

IDF(ti)=log₁₀(N/DF(ti)) (1)

chronological incremental TFIDF (ti, dj)=TF(ti, dj)*IDF(ti, dj)

IDF(ti, dj)=log₁₀(Nj/DF(ti, dj)) (2)

The ti is, here, a morpheme having i as an identifier (ID). That is, this is a keyword candidate being an object or target for which the TFIDF (ti, dj) is to be calculated.

The dj represents the j-th unit document. That is, this is a document including a keyword candidate being an object or targe for which the TFIDF (ti, dj) and the chronological incremental TFIDF (ti, dj) are to be calculated. Here, the unit of the document can be arbitrarily set, such as a chapter, an article, a sentence, etc., and an article of the web news is taken as a document unit in this embodiment.

The TFIDF (ti, dj) and the chronological incremental TFIDF (ti, dj) are values calculated for each morpheme ti in the j-th unit document.

The TF (ti, dj) is a value calculated for each morpheme of the j-th unit document, and is the number of appearances of the morphemes ti in the unit document dj (total number).

The DF (ti, dj) is the number of unit documents that the morpheme ti appears in the first to j-th unit documents.

It should be noted that the aforementioned Nj is the number of unit documents appearing while the unit document dj occurs, and if an ID of the numerals is applied in due order to the unit documents from one (1), the value of N is actually the same value as

It is assumed that morphemes t1, t2, t3, . . . appearing in respective articles (unit documents) d1, d2, d3, . . . change as shown in FIG. 5, for example. In this case, a table in which the number of unit documents Nj is included in each field is shown in FIG. 6(B). Furthermore, a table in which the DF (ti, dj) of each unit document is included in each field is as shown in FIG. 7(B), and a table in which a chronological incremental TFIDF (ti, dj) value of each unit document having the morpheme ti as an identifier by the value of the Nj is included in each field is as shown in FIG. 8(B). These tables are sequentially accumulated in the text database 16.

In this manner, the chronological incremental TFIDF is calculated in the step S11, and then, in a succeeding step S13, the computer 14 calculates a Σ chronological incremental TFIDF being a cumulative total value of the chronological incremental TFIDF and a Σ TF being a cumulative total value of the TF as actual measurements prior to that corpus Ct. Here, since the chronological incremental TFIDF (ti, dj) is as shown in FIG. 8(B), and the DF (ti, dj) is represented by FIG. 7(B), the TF (ti, dj) can be calculated as well, and the ΣTF, after the TF (ti, dj) is calculated, may be calculated as the cumulative total value thereof. Here, the Σ chronological incremental TFIDF may be calculated as the cumulative total value from the table in FIG. 8(B).

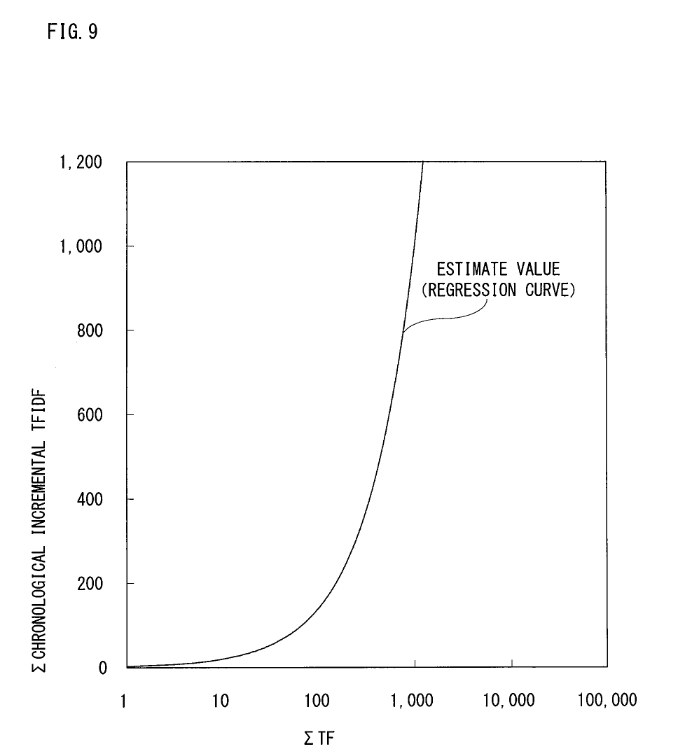

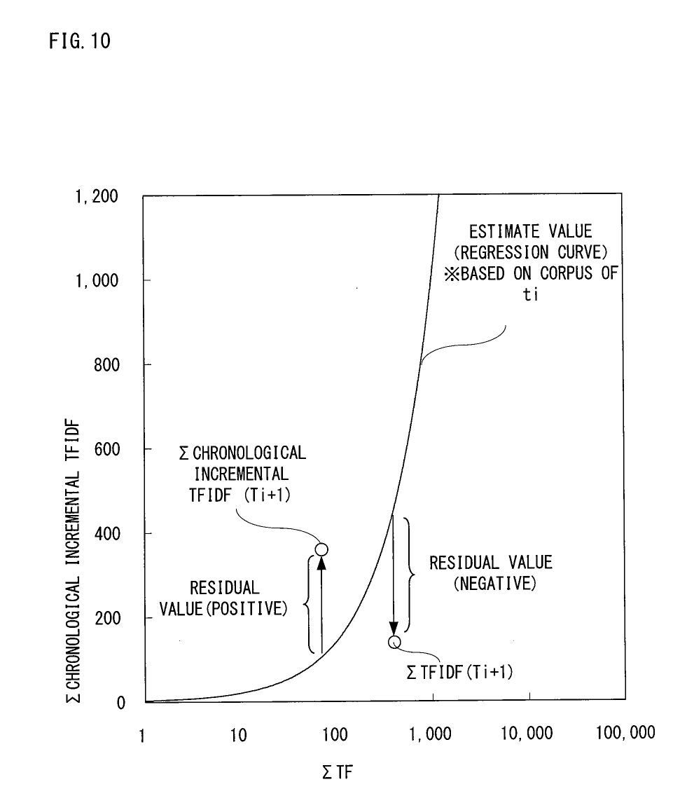

In a succeeding step S15, the computer 14 evaluates a constant a and a constant b by assigning the ΣTF being the cumulative total value of the TF (ti, dj) evaluated as for the corpus Ct to X, and the Σ chronological incremental TFIDF being the cumulative total value of the chronological incremental TFIDF (ti, dj) to Y of the following equation (2) to thereby produce a regression curve shown in FIG. 9. This regression curve is for estimating or anticipating the chronological incremental TFIDF in a next corpus Ct+Δt for a residual analysis in that corpus Ct+Δt. That is, when the ΣTF before that corpus Ct is as an abscissa, if the chronological incremental TFIDF represents the same tendency in the next corpus Ct+Δt as well, the chronological incremental TFIDF in the next corpus Ct+Δt is to be plotted on the regression curve.

Y=aX^{b} (2)

Then, the computer 14 evaluates a difference (residual value) between the Σ chronological incremental TFIDF being the cumulative total value of the chronological incremental TFIDF (ti, dj) in the corpus Ct at time j calculated in the preceding step S13 and the estimate value by the regression curve Y=aX^{b} evaluated in the step S15 with respect to the previous corpus Ct−Δt in the step S17 (FIG. 10). Getting larger in the residual value means that it is apart from (deviated from) the Σ chronological incremental TFIDF of the same morpheme ti estimated in the immediately-before corpus Ct−Δt irrespective of being positive and negative, that is, it can not be estimated from the common knowledge before the immediately-before corpus. On the other hand, a morpheme whose Σ chronological incremental TFIDF indicates a positive residual value is plotted above the regression curve, and this means to be peculiar or characteristic. The morpheme whose Σ chronological incremental TFIDF indicates a negative residual value has no characteristics and is an ordinary morpheme having an opposite characteristics.

Referring to FIG. 10, in a case that the Σ chronological incremental TFIDF of the morpheme ti can be plotted above the curve with respect to the regression curve shown by Y=aX^{b}, this morpheme ti has a positive residual value. Taking the positive residual value means that the morpheme ti scarcely appears before the Ct−Δt. The Σ chronological incremental TFIDF of the morpheme ti+1 is below the regression curve, and this means that this morpheme ti+1 often appeared before.

In the step S17, a residual analysis is performed between an estimate value or a anticipated value of the Σ chronological incremental TFIDF and an actual measurement for each morpheme, to thereby successively store the feature value, that is, the residual value for each morpheme, like adding it to the text data table 20 (FIG. 2) of the database 16, for example, as meta data.

In a step S19, when it is determined that the residual analysis is ended with respect to the last morpheme, the computer 14 selects unique terms (keywords) and general words or ubiquitous terms according to the feature value (residual value) stored in the database 16 as described above in a next step S21. For example, morphemes that each of the positive residual value is an upper predetermined number ranking are selected as unique terms, that is, keywords representative of the corpus. On the contrary thereto, morphemes that each of the negative residual value is a lower predetermined number ranking are selected as general words or ubiquitous terms. The general term corresponds to the keyword representative of the entire constructed text database (linguistic material). Accordingly, if the general term is used, text data (linguistic material) with the same theme can be effectively found.

Succeedingly, the computer 14 displays the unique terms and the ubiquitous terms which are selected in the step S21 on the display not shown in a final step S23.

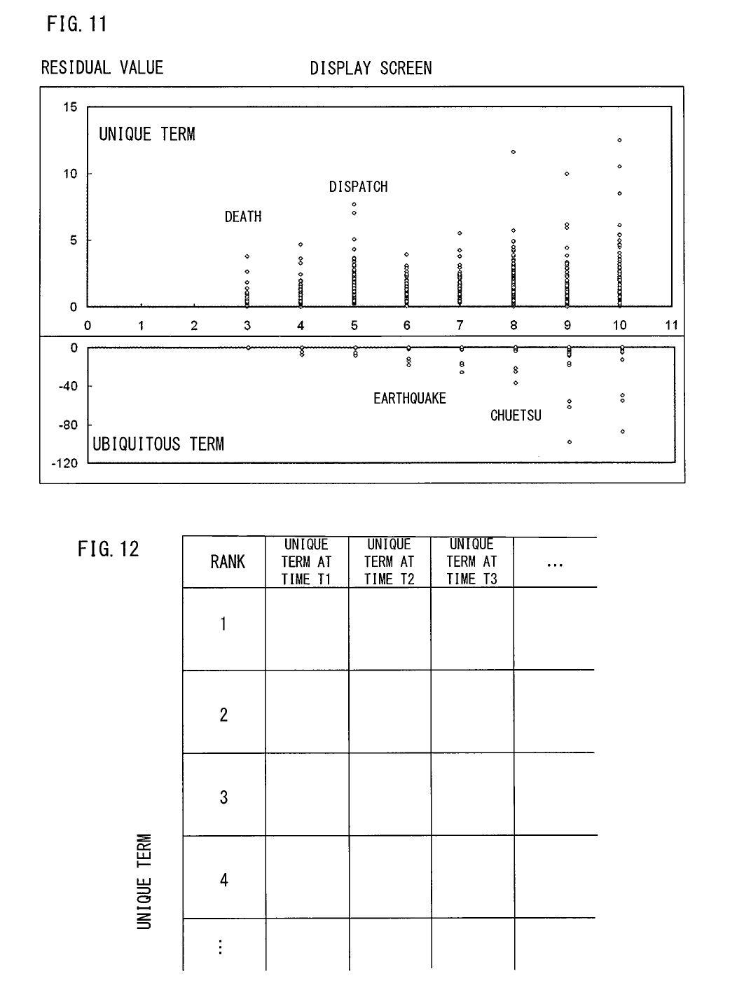

In the display example in FIG. 11, unique terms each having the positive residual value are plotted on the upper side of the display screen with passage of time (abscissa), and ubiquitous terms each having the negative residual value are plotted on the lower side thereof. Since a detailed illustration is difficult in FIG. 11, only two of “death”, “dispatch” are clearly displayed as unique terms, and only two of “earthquake”, “Niigata” are clearly displayed as ubiquitous terms, but it should be noted that in each part of the graphs, morphemes (words) making up of the graph are displayed. According to the display example shown in FIG. 11, the unique terms and the general words are separately displayed between the upper side and the lower side, and this offers an advantage of capable of viewing them at a glance.

As a display example, a display of a tabular form shown in FIG. 12 can be contrived as well. In the table in FIG. 12, the abscissa indicates a time passage, and the ordinate indicates unique terms every time slot by an appropriate number from the upper rank.

Here, of course, another arbitrary display form can be contrived, and the display is not restricted to the display examples in FIG. 11 and FIG. 12.

In the experiment actually made by the inventor, et al., some pieces of web news issued as to the Niigata-ken Chuetsu Earthquake (occurred at 17:56, Oct. 23, 2004. Magnitude 6.8) in 2004 were used. The reason why the Niigata-ken Chuetsu Earthquake disaster is taken as a target is that it is considered this is a relatively large-scale disaster occurred in this country after the popularization of the Internet, and this makes it possible to collect and analyze a large number of news articles.

The news articles in relation to the Niigata-ken Chuetsu Earthquake disaster delivered on the news contents of the typical portal site after Oct. 23 2004 were collected to thereby produce a database by taking a transmission date and time, a releasing newspaper office, a title (headline), a body of article as fields. A work of collecting all the articles within 24 hours from the update on the portal site is performed. The collecting period is about 6 months ranging from the occurrence of the disaster to Apr. 30 2005. The number of collected pieces of web news is 2623. On the day when the earthquake occurs, the first news articles were updated at 6:59 p.m., and 42 pieces were transmitted during that day. The day when the number of articles is the most was the next day of 24th to the occurrence of the earthquake and 179 pieces.

The text data of the web news in relation to the aforementioned Niigata-ken Chuetsu Earthquake disaster collected during the 6 months were registered as text data table 20 shown in FIG. 2 in the text database 16 (FIG. 1).

Thereafter, for the purpose of specifying the keyword candidate (morpheme), a morphological analysis is executed in accordance with the step S5 to study units of the term to be adopted as a keyword, and according to the step S7, units which are not proper to the keyword were removed from the units of the term decided in the step S5.

Japanese language can be segmented into units, such as a paragraph, a sentence, a segment, a term, a letter or character, etc., and the unit generally used as a keyword is a term. However, for the study of Japanese language, there is no strict definition for a term. For example, in a case of the “Niigata-ken Chuetsu Earthquake”, this can be considered as a term as it is, but this can be divided, such as (1) “Niigata/ken/Chuetsu/Earthquake”, (2) “Niigata ken/Chuetsu/Earthquake”, (3) “Niigata ken Chuetsu/Earthquake”. Since there are plurality of patterns in accordance with ideas and viewpoints, this consideration with respect to such a compound term makes it difficult to objectively specify words.

Hence, in this embodiment, it is decided to cut out words which can be extracted as a keyword by the morphological analysis generally being used.

It should be noted that the experiment dealt with Japanese language, and thus the morphemes or words are almost of Japanese language.

One example of the result of the morphological analysis is shown: “Niigata/Ken/Chuetsu/Jishin/wa/jyumin/no/raifu rain/ni/mo/zindai/na/higai/wo/oyoboshi (oyobosu)/ta/.” The analysis result in the aforementioned example (1) is output, and with respect to the morpheme taking an inflected form of a term, a basic form is also output like “oyoboshi (oyobosu)”. The morphological analysis attains accuracy of 96-98% or more at the current technical level.

The unit of the morpheme is, here, adopted as a unit of a keyword. In the unit of the morpheme, a compound term such as the “Niigata-ken Chuetsu Earthquake” cannot be gotten. However, there is no appropriate concept or definition as to a term at the present stage, and there is no analytic method for cutting a term out of the language data. The unit of the morpheme allows analysis with high accuracy, and therefore, in this research, the unit of the morpheme is made as a candidate of keyword.

As a result of attempting a morphological analysis on all the articles of the web news, 15211 kinds of morphemes (morphemes of 623765 in total) can be obtained.

Succeedingly, removal of unnecessary words is performed. In the morpheme cluster obtained by the morphological analysis, some are not fit for keywords. The words which are not fit for the keywords here indicate morphemes which do not have a meaning in themselves, like a postpositional term, such as “ga”, “wo”. Generally, such terms are called an unnecessary term (unnecessary morpheme). It is impossible to gain the meaning and the content from the unnecessary term itself.

By noting the parts-of-speech of each morpheme obtained by the morphological analysis, the removal of morphemes which are not fit for the keyword is studied from the difficulty belonging to such unnecessary terms. The parts-of-speech regarded as an unnecessary term are determined on the basis of the parts-of-speech information adopted by the morpheme analyzing system used in this embodiment.

The postpositional term (“ga”, “wo”), an auxiliary verb (“reru”, “rareru”), a conjunction (“shikashi”), and a symbol (“punctuation marks”) are the parts-of-speech having a grammatical function, but have no meaning in themselves and are not suitable for a keyword. Furthermore, the parts-of-speech which make sense by being connected to other morphemes cannot make sense by one morpheme, and thus are not suitable for a keyword. This corresponds to a morpheme which takes a non-independent form and a suffix form (“koto”, “shimau”, “rashii”), a conjunctive noun (“tai”, “ken”), a prefix (“o”, “yaku”), and a prenoun adjectival (“kono”, “sono”) out of the noun, verb, and adjective. Besides, a pronoun (“sore”, “watashi”) which indicates other words and thus cannot have a meaning of itself, and a filler (“eeto”, “unto”) for taking a rest are not suitable for a keyword as well. Furthermore, since an interjection (“ohayou”, “iie”) such as greetings, supportive responses are mainly used during a conversation, it is considered that this is less related to a disaster event.

When the aforementioned parts-of-speech is removed, morphemes which do not take a non-independent form and a suffix form out of the noun, verb, adjective and an adverb are adopted as candidates for keyword.

As a result of removing the unnecessary words on the basis of the parts-of-speech information, 15211 kinds of morphemes evaluated in the morphological analysis (step S5) are decreased to 14109 kinds (521240 morphemes in total). Out of the 14109 kinds, 1122 kinds of the morphemes (72 article) appeared from 1 to 10 hours after the occurrence of the earthquake, 3581 kinds of the morphemes (481 articles) appeared from 10 to 100 hours, 5691 kinds of the morphemes (1230 articles) appeared from 100 to 1,000 hours, and 2716 kinds of the morphemes (840 articles) appeared from 1000 to 4529 hours.

Next, according to the aforementioned equation (1), by weighing each of the extracted keyword candidates extracted from the news articles, the keyword was evaluated such that how characteristic the keyword is, or how important the keyword is as a keyword representative of the change within a certain time period.

If information on the index indicating the degree of characteristics is added to the keyword at a certain time point, a characteristic keyword can be specified on the basis of the evaluation result of the index. Thus, in this embodiment, by executing the step S11, applying an index indicating the degree of characteristics to a keyword is considered.

If a certain matter is mainly transmitted on the web news at a certain time point, a term representing the meaning of the matter may frequently appear. However, out of the keywords frequently appearing, two types of keywords can be assumed, one is keywords which are frequently used for constructing documents in any news articles, and the other is keywords which are frequently used in a part of the news articles. The keyword which characteristically represents news articles indicates the latter.

There is the aforementioned TFIDF as an index of applying a high or heavy weight to the latter keyword. As described above, when the TF (ti, dj) indicates the number of keywords ti appearing in the article dj, and the DF (ti) indicates the number of documents in which the keyword ti appears, and the IDF (ti) is an inverse number of the ratio of the number of documents in which the keyword ti appears to the total document number. That is, in this embodiment, a low or light weight is applied to a morpheme which seems to appear in any articles, and a high or heavy weight is applied to a morpheme which seldom appears in other articles. The chronological incremental TFIDF taking a product between the IDF and the TF is an index for representing how frequently the keyword appears in the article, and how rarely the keyword appears in other articles, and it can be said the that this is an index for evaluating the degree of characteristics of the keyword.

Then, in a case of evaluating a chronological incremental TFIDF with respect to a certain article dj in this embodiment, not the N and DF based on the total articles of 2623 finally collected, but the Nj (the total number of the articles before the article dj is transmitted) considering a time based on the number of articles which has been transmitted before the article dj is issued and the DF (ti, dj) (the number of documents in which the morpheme ti appears before the article dj is transmitted) are used to successively calculate a TFIDF at a time point when the article dj is transmitted. This is called a chronological incremental TFIDF.

As an example of a linguistic material body which increases in the course of time, materials in relation to a risk and/or disaster are enumerated. The linguistic material in the risk management field increases in number with time from the occurrence of the risk or disaster. A normal TFIDF takes constant N and DF, and does not respond to the weighting with respect to the morpheme extracted from the linguistic material increased in time series. In this embodiment, the total document number and the number of documents in which an arbitrary morpheme appears are regarded as parameters changing based on the chronological information to thereby use the TFIDF with modification. Additionally, if the TFIDF is thus evaluated, in a case that the TFIDF of a morpheme first appearing at a time when the article dj is issued is evaluated, the DF becomes 1, and the IDF is evaluated to be high, and a high weight is consequently applied to the morpheme which first appears. As described above, the index considering the concept of the time is called the chronological incremental TFIDF.

Here, it is difficult to evaluate whether or not the keyword is characteristic by only the value of the chronological incremental TFIDF. As a pattern in which the value of the chronological incremental TFIDF at a certain time point is highly evaluated, there are a case that even if the value of the TF is low, since the IDF is high (DF is low), the chronological incremental TFIDF is evaluated to be a high value, and a case that even if the IDF is low (DF is high), sine the TF takes a significantly large value, the chronological incremental TFIDF is calculated to be a high value. The fact the TF is significantly large is that it is highly possible that the term is, due to the high generality of the term, a term which has to be used many times for describing the articles. It is thus impossible to simply evaluate whether the keyword is characteristic by the value of the chronological incremental TFIDF.

The fact that the information at a certain time point is characteristic can be grasped from the comparison between a set of keywords which had been talked at a previous time point and a set of keywords which has been talked at a certain point. If there is a difference between them, this seems to mean that there is a great difference in quality before and after an arbitrary time point. That is, by comparing the corpus at a certain point and a corpus after an arbitrary time elapses from the certain point, it is considered that it is possible to grasp a change of the quality of the information, and specify the keyword which brings about the change.

Here, in this embodiment, as described above, by performing a residual analysis (step S17), the characteristics of the corpuses at a certain point and a next time point were compared with each other.

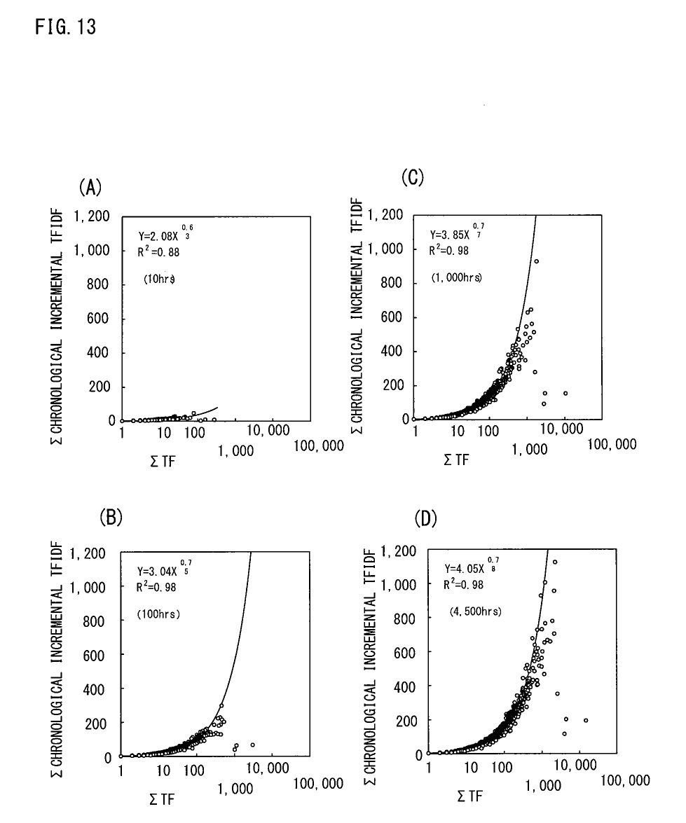

FIG. 13 plots a relationship between a cumulative total value of the TF for each morpheme and a cumulative total value of a chronological incremental TFIDF for each morpheme until 10 hours (FIG. 13(A)), 100 hours (FIG. 13(B)), 1000 hours (FIG. 13(C)), and 4500 hours (FIG. 13(D)) after the occurrence of the disaster. There was a strong relationship between the cumulative value of the TF and the cumulative value of the chronological incremental TFIDF as shown in the aforementioned equation (2). When the relationship between both of them is viewed in the function (linear function) of this equation (2), Y=0.16X+3.14 (R2=0.24) for 10 hours, Y=0.07X+10.47 (R2=0.13) for 100 hours, Y=0.11X+18.46 (R2=0.15), and Y=0.15X+22.27 (R2=0.18), and this means to be short of ones of involution (power). Additionally, beside the elapsed time from the occurrence of the disaster, there is a similar tendency, and with respect to cases except for a case of the relationship between the cumulative total value of the TF and the cumulative total value of the chronological incremental TFIDF within 10 hours being less in the number of samples (the number of keywords), in a case of an involution (power) function, R2 is 0.90 to 0.99, and in a case of a linear function, R2 is 0.13-0.17, and therefore, it became evident that there is systematically a relationship of the involution (power) function between the cumulative total value of the TF and the cumulative total value of the chronological incremental TFIDF.

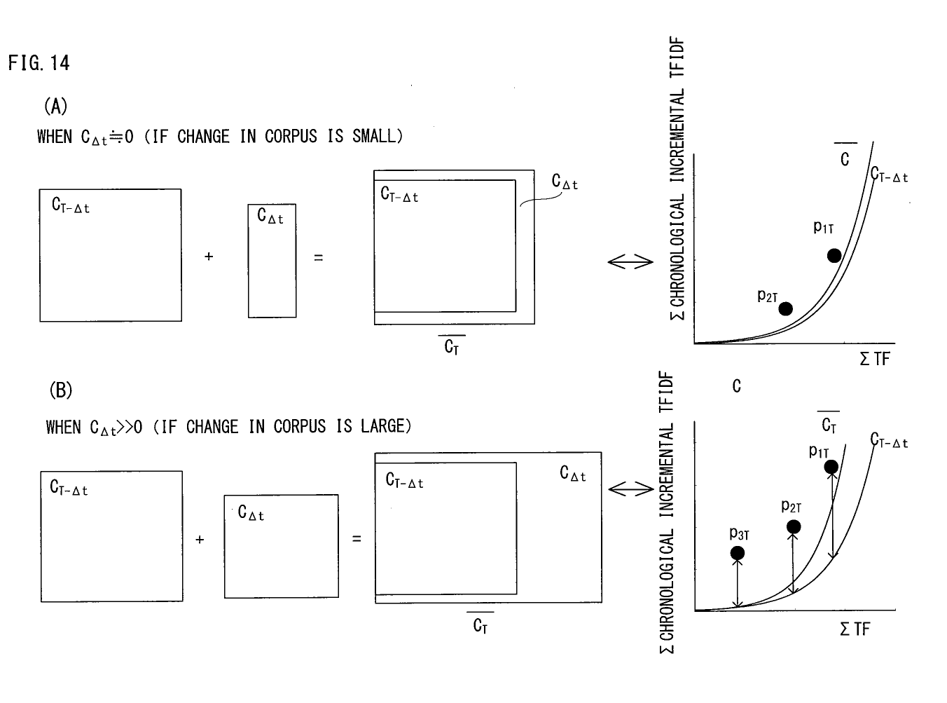

The functional relationship shown in FIG. 13 means that as for the keywords in the vicinity of the approximate curve, the relationship of the cumulative total value of the TF and the cumulative value of the chronological incremental TFIDF has a similar tendency to an average relationship of the corpuses. It is considered that the keyword having such a tendency exhibits an average appearing pattern. Accordingly, in a case that the actual cumulative total value of the chronological incremental TFIDF is below the estimate value based on the approximate curve, viewed from the average of the corpuses, this shows that the cumulative total value of the chronological incremental TFIDF is low, that is, the degree of characteristics is not so high. On the contrary thereto, in a case that the actual measurement is above the estimate value, it can be said that the chronological incremental TFIDF is conversely high and this is the characteristic keyword. The evaluation described above is made possible by evaluating the difference (residual) between the actual cumulative total value of the chronological incremental TFIDF and the estimate value based on the approximate curve. By applying the above-described relationship, the degree of characteristic of a keyword at a certain time point is evaluated in the mode in FIG. 14.

FIG. 14 schematically shows, at the left side, a change of the corpus when a unit time Δt elapses from a time t−Δt. This relationship can be represented by a following equation (3).

C̅=Ct−Δt+CΔt (3)

Here, the C̅ is a corpus at a certain time t, the Ct−Δt is a corpus extended back by Δt from the certain time, and the CΔt is a corpus increased from the time t−Δt to the certain time t.

As shown in FIG. 14(A), in a case that a number of keywords which have already appeared are included in the CΔt, or in a case that only the morphemes each being a low frequency of appearance exist in the CΔt, as shown in the upper right of FIG. 14, the relationship between the cumulative total value of the TF and the cumulative total value of the chronological incremental TFIDF does not yield so large difference between the case of being constructed by the corpus at the time t−Δt and the case of being constructed by the corpus at the time point t. On the contrary thereto, as shown in FIG. 14(B), in a case that keywords which had not appeared before the t−Δt appear in the Δt, or in a case that a morpheme appearing at a high frequency exists in the Δt, the corpus significantly changes at the time t, and as shown in the lower right of FIG. 14, the form of the curve representing the relationship between the cumulative total value of the TF and the cumulative total value of the chronological incremental TFIDF largely changes.

That is, the residual between the cumulative total value of the chronological incremental TFIDF at the certain time t and the estimate value based on the relational expression constructed by the corpus at the time t−Δt indicates the changes of the corpus itself during the time Δt, and only the morpheme with a large residual is considered to be a keyword representative of the content of the linguistic material occurring during the time Δt.

Thus, in this embodiment, as an index for evaluating a feature amount of a keyword indicating the change in the quality of the information content at the time t, a difference (residual) is adopted between the estimate value of the cumulative total value of the chronological incremental TFIDF by the relational expression based on the TF constituted of corpuses at an arbitrary time period t−Δt and the cumulative total value of the chronological incremental TFIDF, and an actual measurement of the cumulative total value of the chronological incremental TFIDF at the time t. The keyword taking a markedly high residual is here called a characteristic term or a unique term (residual value: positive), and the keyword taking a markedly low residual is called a general term or a ubiquitous term (residual value: negative).

According to a process shown in the flowchart in FIG. 3, the document analyzing apparatus 10 shown in FIG. 1 embodiment is configured by utilizing a chronological incremental TFIDF index and a quantitative index like a residual value not by using a subjective determination by a person but by the computer 14, and is configured by successive processes, so that if a tool and something to be referred are properly prepared, by using records of crises in the past as an input, keywords as final resultants can be detected automatically and objectively through the series of processes.

In this manner, in the document analyzing apparatus 10 shown in FIG. 1 embodiment, the computer 14 executes following steps in brief.

1) A database of text data (some pieces of web news in this case) increasing in time series is constructed.

2) Each text is segmented into morphemes to which parts-of-speech information is added.

3) On the basis of the parts-of-speech information, nouns, verbs, adverbs, adjectives except for the non-independent form or the suffix form thereof are extracted.

4) The TF and the chronological incremental TFIDF based on the chronological information with respect to morphemes for each document (web-news article, here) are evaluated.

5) In order to extract keywords representative of characteristic texts from the time t−Δt to the time t, a relational expression between the cumulative total value of the TF and the cumulative total value of the chronological incremental TFIDF in the corpus until the t−Δt is evaluated, and the difference between the estimate value and the actual measurement of the cumulative total value of the chronological incremental TFIDF at the time t is evaluated based thereon. This residual value is regarded as a feature amount of each of the keywords which appears during the time Δt.

6) The keywords in arbitrary upper ranks from the largest residual value are selected, and with respect to the articles in which the keywords are detected, the keywords are taken as meta data of the linguistic material.

The system in this embodiment is intended to be applied to pieces of web news taking up the Niigata-ken Chuetsu Earthquake disaster in 2004.

According to the model of the course of the disaster which has already been implemented by carefully taking an ethnography from a microscopic viewpoint as to the actions of the victims directly after the occurrence of the disaster of the Great Hanshin Awaji Earthquake, it is said that with respect to the course of the disaster, a condition is changed in quality according to a power of 10, such as 10 hours, 100 hours, 1000 hours. The period from 1-10 hours is said to be a disorientation period or a period of disaster during which it is impossible to grasp what happens due to the drastic changes in the environment by the disaster, and the next period from 10-100 hours is a formation period of a society of a disaster area during which activities of saving life, an establishment of shelters, and the like are performed. The period from 100-1000 hours is a period during which the society of the disaster area is maintained, a flow of the society is restored, and the life of the victims of the disaster is stabilized. The period from 1000 hours onward corresponds to a period returning to the reality during which a reconstruction of a social stock is performed.

With reference to the model of the course of the disaster, a keyword detection was tried by setting the Δt to be used in the keyword detection to 1 hour, 3 hours, 8 hours, 8 hours, 24 hours, 24 hours, and 24 hours in respective seven phases, such as 1-10 hours, 10-100 hours, 100-500 hours, 500-1000 hours, 1000-2000 hours, 2000-3000 hours, and 3000-4500 hours.

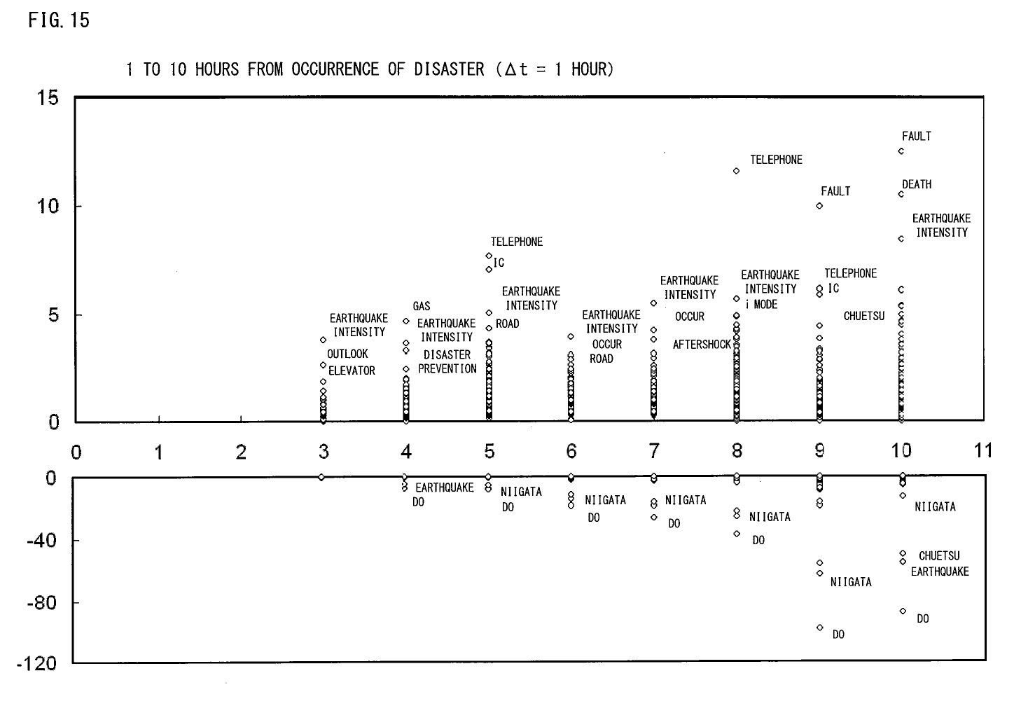

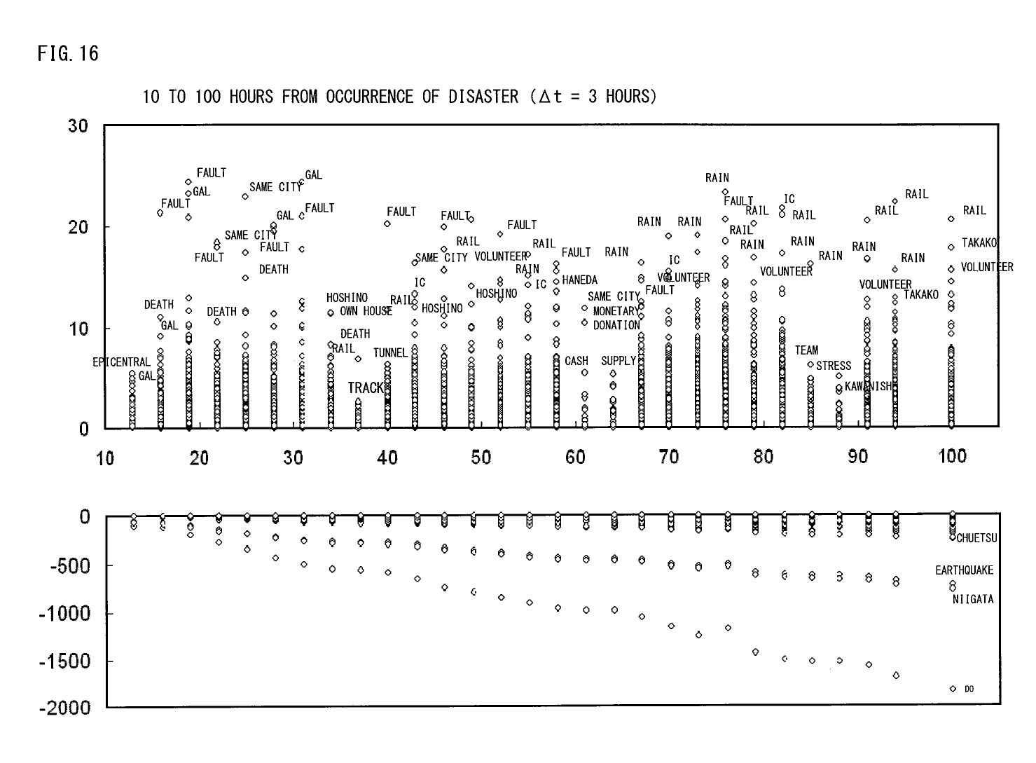

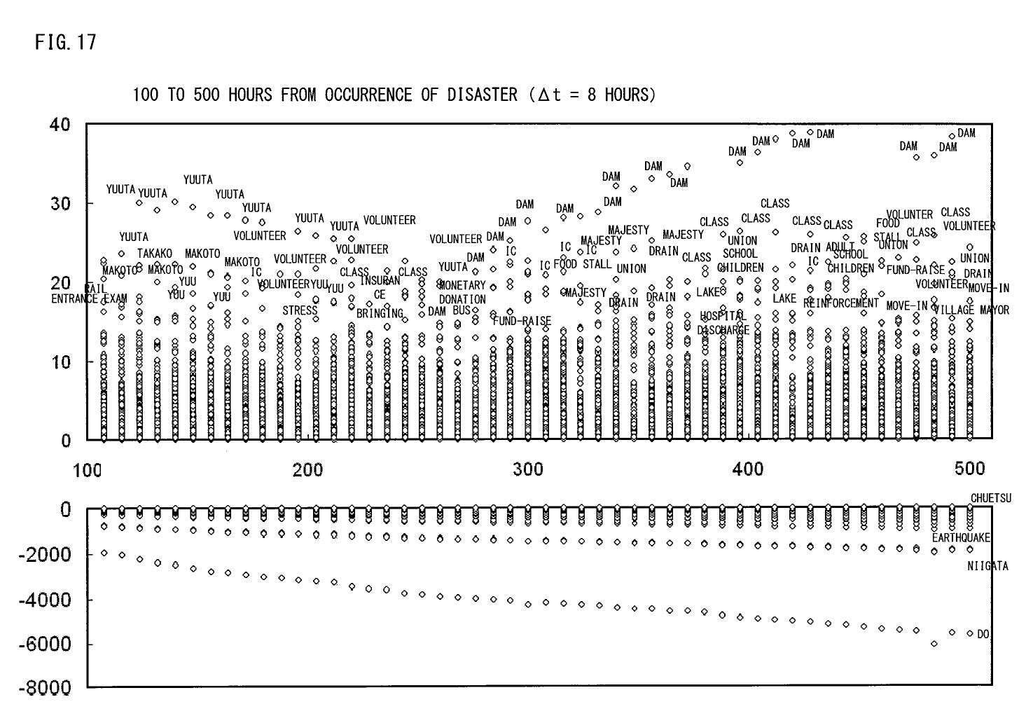

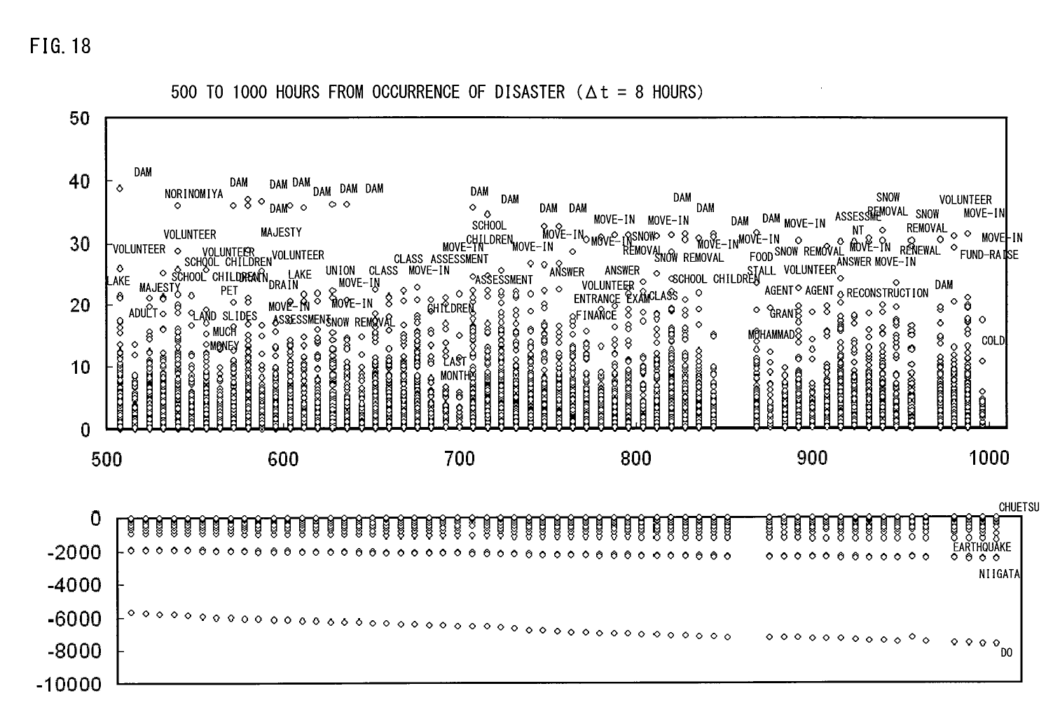

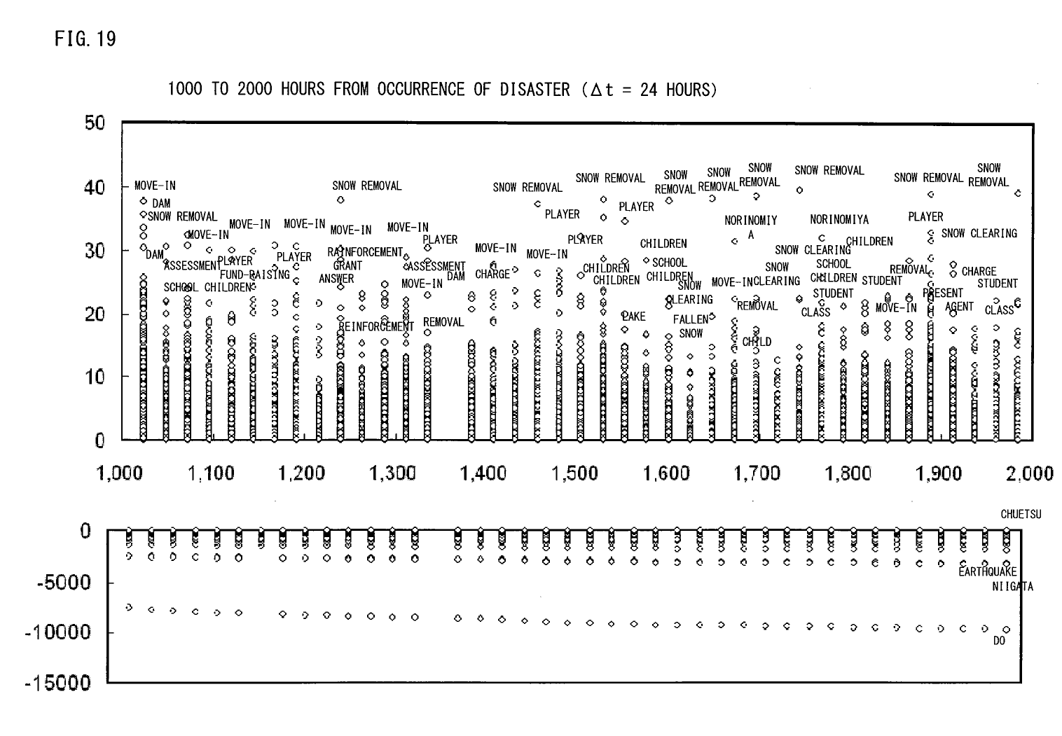

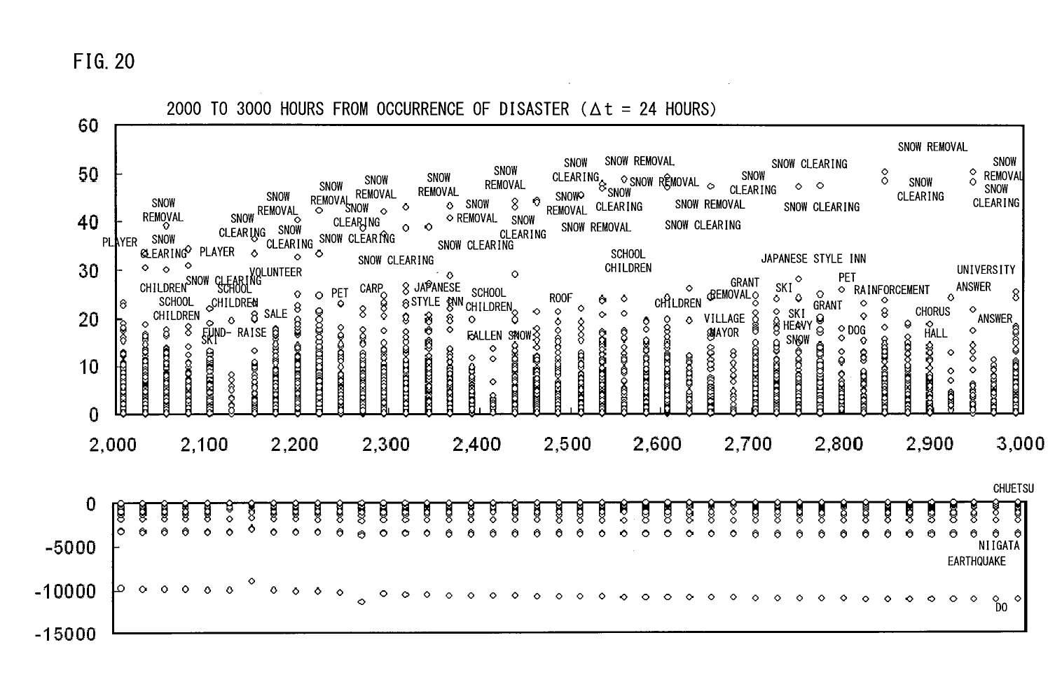

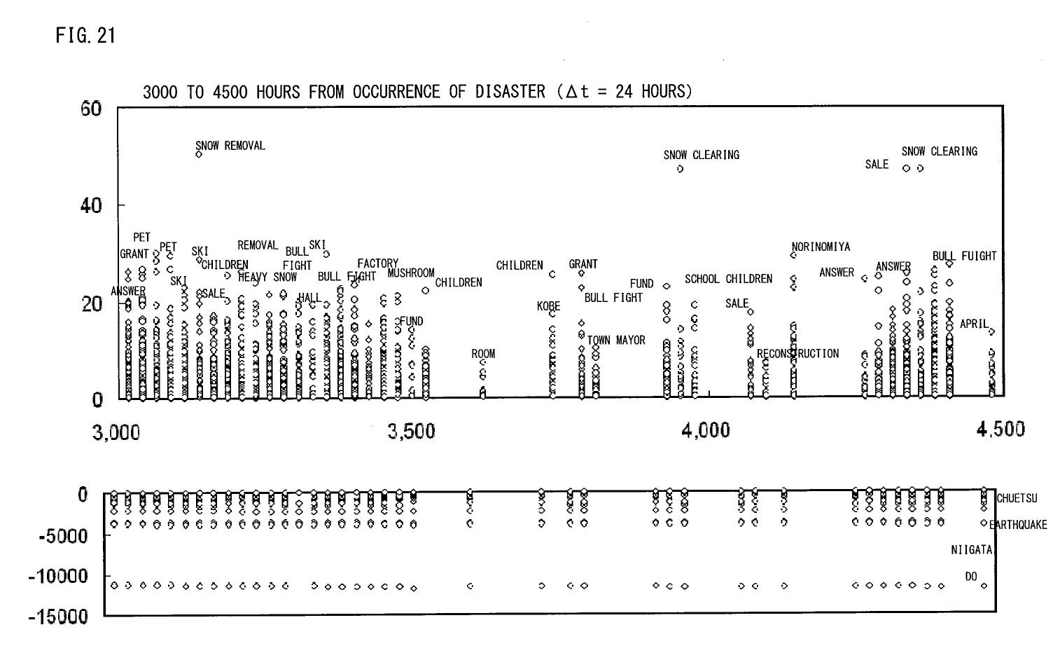

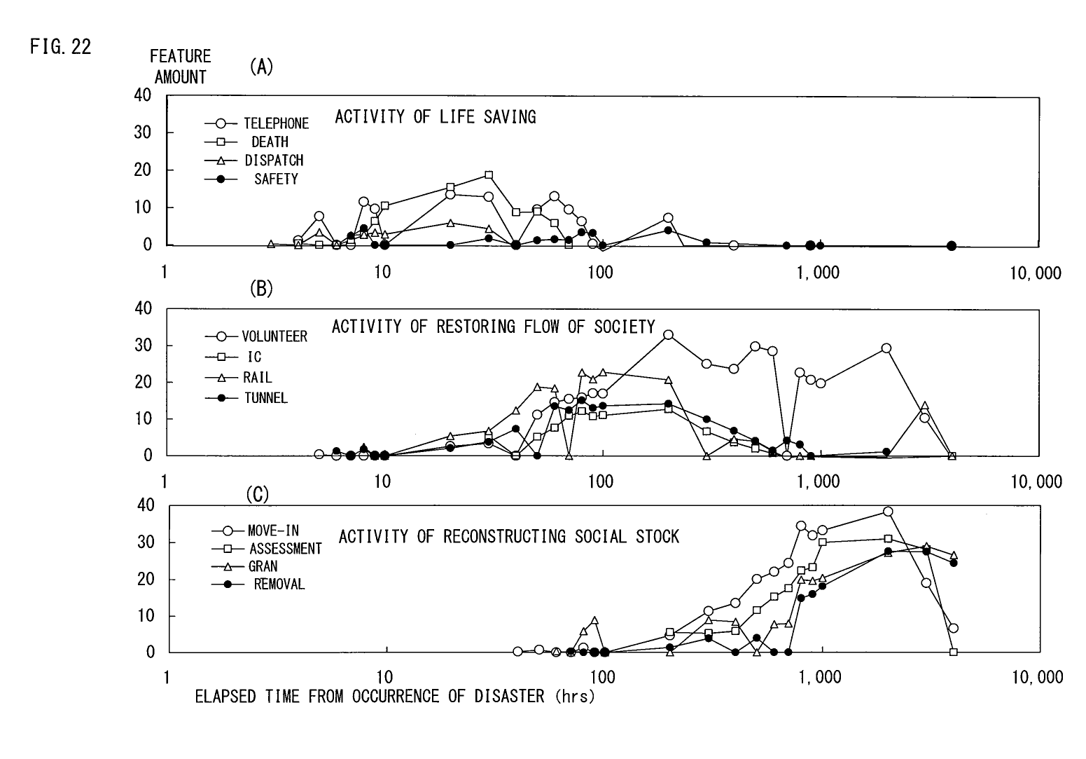

FIG. 15-FIG. 21 shows a distribution of the plots of the feature amount (residuals) the detected respective keywords have. These graphs in FIG. 15-FIG. 21 are displayed on a monitor 15B of the computer 14 shown in FIG. 1. FIG. 22 shows the feature amount of the keywords detected for each time cross section by roughly top three ranks and roughly bottom three ranks. FIG. 22 may be also displayed on the monitor 15B.

In order to more observe what kinds of keywords detected in FIG. 15-FIG. 21 are, with respect to the keywords whose feature amount is within the top 10 in each time section, the number of times are counted and shown in a Table 1. In the Table 1, the keywords which can be rated as being within the top 10 twice or more are shown. In the detected main keywords, the “volunteer” is the most, and followed by the “IC (interchange)” and the “fault or dislocation”.

By noting the keywords in associated with these activities in FIG. 15-FIG. 21 and the Table 1, the developments of them in time series is intended to be observed.

TABLE 1
List of the keywords each having a residual value rated
as being the top 10 at each time

| cross section | | |
|---|---|---|
| 1st place | volunteer | 14 |
| 2nd place | IC | 13 |
| 3rd place | fault | 11 |
| 4th place | earthquake intensity | 9 |
| | dam | 9 |
| 4th place | school children | 9 |
| 5th place | rail | 7 |
| 6th place | telephone | 6 |
| | get up | 6 |
| 6th place | the same city | 6 |
| | tunnel | 6 |
| | rain | 6 |
| | union | 6 |
| | move-in | 6 |
| 7th place | death | 5 |
| | Haneda | 5 |
| 7th place | class | 5 |
| | lake | 5 |
| | children | 5 |
| | assessment | 5 |
| | snow removal | 5 |
| 8th place | grant | 4 |
| | aftershock | 4 |
| 8th place | landslide | 4 |
| | sequel of the Table 1 | |
| | current | 4 |
| | possible | 4 |
| | gal | 4 |
| | acceleration | 4 |
| | Hoshino | 4 |
| | villager | 4 |
| | Yuuta | 4 |
| | drain | 4 |
| | answer | 4 |
| 9th place | road | 3 |
| | own house | 3 |
| | mountain | 3 |
| | monetary donation | 3 |
| | Tsubame-Sanjo | 3 |
| | food stall | 3 |
| | sequel of the Table 1 | |
| 9th place | player | 3 |
| | snow clearing | 3 |
| 10th place | disaster management | 2 |
| | dispatch | 2 |
| | safety | 2 |
| | occurrence | 2 |
| | present | 2 |
| | inside the prefecture | 2 |
| | sequel of the Table 1 | |
| | earthquake center | 2 |
| | small country | 2 |
| | toilet | 2 |
| | Takako | 2 |
| | insurance | 2 |
| | Yuu | 2 |
| | majesty | 2 |
| | adult | 2 |
| | Norinomiya | 2 |
| | reinforcement | 2 |
| | fund-raise | 2 |
| | agent | 2 |
| | Japanese-style inn | 2 |
| | pet | 2 |
| | removal | 2 |

Next, with reference to FIG. 22, how the feature amounts of the detected keyword change with passage of time is considered. It is said that there are three major activities in order to respond to the disaster. The first is an activity of saving life, and examples are a rescue, a confirmation of safety, a prevention of a secondary disaster, etc. The second is an activity for stabilizing the flow of the society, and includes an establishment of shelters, restoration of lifelines, a provision of an alternative means, etc. The third activity is an activity for reconstructing a social stock, and intending to reconstruct the cities, the economy, and the life.

FIG. 22(A) shows temporal changes of the feature amounts of the “telephone”, the “death”, the “dispatch”, and the “safety” which seem to be associated with the activities of saving life. The “telephone” and the “safety” are in the article in relation to the confirmation of safety, “From directly after the occurrence of the earthquake, the line is busy for a confirmation of safety and inquiries (10/24 1:19 Yomiuri Newspaper)”, the “death” is in the article reporting the occurrence of the death, and the “dispatch” is in the article reporting that “the Metropolitan Police Board dispatched Interprefectual Emergency Unit to the disaster area in Niigata Prefecture at night of 23th in response to a call-out from the Director-General of the National Police Agency (10/23 22: 05 Mainichi Newspaper)”. These keywords reach their peaks in the feature amount from 10 to 100 hours after the occurrence of the disaster, and then take the negative values in the feature amount, and are ranked as keywords with high generality. The “death” takes the lowest negative value in the feature amount after 100 hours. This is because the summary of the damage of the disaster, such as “one month has passed on 23th after the occurrence of the Niigata-ken Chuetsu Earthquake. The death was 40, the injured was risen to about 2860, the damaged houses was about 51500 (11/23 1: 25 Kyodo News Service)”, is frequently reported, so that the generality of “death” in the entire corpus seems to be high.

FIG. 22(B) shows changes of the feature amounts of the “volunteer”, the “IC”, the “rail”, and the “tunnel” in relation to the activity of restoring a flow of the society. The “volunteer” plays a role in assisting an alternate function in restoring the social flow, and the “IC”, the “rail”, and the “tunnel” are for making up of a traffic lifeline. These, except for the “tunnel”, take a maximum feature amount from 100 to 1000 hours after the occurrence of the disaster. With respect to the traffic lifeline, together with the report about the damage “the Kanetsu Expressway is closed off between Nagaoka Junction on the up lane (JCT) and Yuzawa IC, between Tsukiyono IC on the down lane and Nagaoka JCT (10/26 0:27 Kyodo News Service)” and the report about the restoration “the regulation between Nagaoka Junction and and Nagaoka IC of the Kanetu Expressway on the up and down lanes, and the regulation between Muikaichi IC-Yuzawa IC on the up lane are canceled (10/27 1:58 Kyodo News Service)” were transmitted during this period. With respect to the “rail” and the “tunnel”, as to the Shinkansen train derailment accident that occurred in the Niigata-ken Chuetsu Earthquake, the report about the restoration was transmitted, such as “JR East (East Japan Railway Company) announces on 26th that a task of returning the derailed Joetsu Sinkansen train “Toki 325” to the rail is started from the 27th (10/27 2:28 Sankei Newspaper)”. In what follows, the “tunnel” frequently appears in articles, and the feature amount consequently takes a negative value 1000 hours after.

Lastly, a similar analysis is intended as to the activities of reconstructing the social stock.

FIG. 22(C) shows changes in the feature amounts of the “move-in”, the “assessment”, the “assistance”, and the “removal (group removal)”. These are keywords in relation to the reconstruction of the houses, such as “move-in (example of the article: the victims in Yamakoshi village move into temporary houses constructed in Nagaoka city at the morning of 10th (12/10 18:28 Mainichi Newspaper))”, and the “assessment (example of the article: with respect to the assessment of the damage of the building, 20 households answer that “they do not satisfy the assessment” (12/24 0:05 Yomiuri Newspaper))”. These keywords take the highest feature amounts after 1000 hours from the disaster. Furthermore, with respect to the keywords about the activity for reconstructing the social stock together with the activities for restoring the social flow, and, the keywords are never first appear after 100-1000 hours and after 1000 hours during which the feature amounts of both of them are peaked, but appear in the period earlier than these periods.

From the above-described consideration with respect to the keywords about which the residuals are positive, the keywords assumed in the theory of the course of the disaster on the basis of the result of the ethnography search in the disaster area of the Great Hanshin-Awaji earthquake occurring in 1995 and the linguistic analysis relating to the news articles taken in the WTC terrorist attack in 2001 are characteristically detected for each time phase, and in the analysis result utilizing the web news of the Niigata-ken Chuetsu Earthquake disaster in 2004, a conformity to the model of the course of the disaster in which a disaster process changes in quality by taking the time of a power of 10 as a milestone was confirmed.

Furthermore, each of the sets of keywords shown in FIG. 22 has a peak point of the feature amount in a phase corresponding to the activity of saving life, the activity of restoring a flow of the society, the activity of the social stock, but not small feature amount is observed during a period to be analyzed taking the period before and after the peak point as the center, and this coincides with the temporally developing model of the disaster response in which the contents of the disaster response do not change with passage of time, but develop in parallel while each of the contents has its peak of the activity.

Some keywords which are not shown in FIG. 22 show a high feature amount in FIG. 15-FIG. 21. In a case of the period from 100-1000 hours after the disaster, the most characteristic is the “dam (an example of the article: a natural “dam lake (natural dam)” which is made by a lot of landslides flown to the Imo river in Ymakoshi village approximately becomes a bankfull stage due to a rainfall from the night of the 1st to the 2nd (11/2 12:53 Mainichi Newspaper))”. It is conceivable that this is because that the “rain” which is characteristics in the previous phase occurs in the disaster area to elevate a risk of the break of the natural dam, so that the feature amount becomes high. From the fact that the disaster area is a heavy snowfall area, an amount of snow cover is more than usual in those days, and due to the fallen snow on the roof, the house whose strength was decreased by the earthquake involves a risk of being broken, keywords, such as the “snow removal”, and the “snow clearing” were also characteristic during this period (January to March).

In accordance with this, the feature amount of the keyword like “volunteer” in relation to the activity for supporting a snow-removing work becomes high again. In a case of the Niigata-ken Chuetsu Earthquake, as the “dam”, the “drain”, the “snow removal”, and the “snow clearing” are detected, it became evident that an influence of a secondary disaster by a natural hazard except for the earthquake, such as an influence of the landslide disaster due to a rainfall occurring after the main quake and a risk of breaking a building due to a heavy snow are taken characteristically.

Although inappropriate words such as the “same city”, the “current time”, and the “possible” which are not fit for the keyword are partly detected, since the keywords representative of each phase from the occurrence of the disaster to the reconstruction are detected as in the aforementioned study based on FIG. 15-FIG. 21, FIG. 22, and the table 1, it is confirmed that detection of keywords indicating the information content of each linguistic material (news articles) is made possible. Furthermore, as words about which the residual is negative in FIG. 15-FIG. 21, “suru”, “Niigata”, “earthquake”, “Chuetsu”, etc. appeared. In addition to the term such as the “suru” which seems to be high frequency of use in any sentences because of the linguistic characteristic of Japanese language, the keywords, such as “Niigata”, “earthquake”, “Chuetsu”, etc. which are included in the name of the disaster (the Niigata-ken Chuetsu Earthquake) used for analysis here show a severely low residual. Generally, since in the name of crisis, the area where the crisis occurs and the name of the hazard are included, by collecting linguistic materials in relation to various crises, the keywords of the area name and the hazard name about which residual is detected to be a severely low negative value when this technique is applied are taken as a “calling tug”, and whereby it is possible to detect a mixing of foreign text data from the linguistic material body.

If visualization (monitor display) is performed by utilizing the feature amounts of the keywords as shown in FIG. 15-FIG. 21, FIG. 22, the linguistic material which is essentially constituted of a number of texts can be reduced to information in time series by taking each keyword as a unit. Offering the changes of the characteristics of the keywords in time series to the user of the XMDB plays a role in allowing a roughly understanding of the process of the disaster, and assisting a selection of a searched keyword when data, information, knowledge and lesson are intended to be obtained from the linguistic material accumulated in the database. Furthermore, if the developed text mining method is applied in real time to the linguistic material collected during occurrence of the disaster, massive amounts of language information is collected objectively and quantitatively. It is considered that this makes it possible to unify the appreciation of the condition between the practionners, and to support the determination of the policy and the determination of the opinions.

Additionally, in the aforementioned embodiment, the text corpus is produced for every set time (S1, S3). However, the text data increasing in time series is accumulated in the text database 16, and a text block, that is, a corpus may be demarcated every lapse of an arbitrary duration Δt.

As described above, the analysis technique of this invention is, as to the appearing distribution words, of comparing the corpus Ct at an arbitrary time point and the corpus Ct−Δt extended back by the Δt from that time point, and extracting a unique term whose appearing characteristic is significantly different between the t−Δt and the t as a unique term. Thus, if a term different from the words of the corpus increasing in time series appears during the Δt, a discriminating value for measuring the peculiarity indicates a high value.

In the analysis technique (algorithm) in this invention, if the discriminating value indicates a high value, two patterns below can be assumed. One is a case that a document (article) which is highly associated with this art at the time point t and includes a lot of words being highly associated with this art is added to the corpus, and the other is a case that a document which is not so highly associated with this art in that point t, and includes words being lowly associated with this art is added to the corpus.

For example, with respect to the web news corpus in relation to the Niigata-Chuetsu Oki (offshore) earthquake in 2007 analyzed by the inventor, et al., in a set of the feature articles, in the news reporting the result of the elimination matches of All-Japan Senior High School Baseball Championship Tournament, the results of the past games of the high schools in Kashiwazaki City being a main disaster area were placed, and therefore, these were added to the corpus. In these articles, the results of the past games played in that day of all the high schools in the Niigata Prefecture are also placed other than the results of the past games of the high schools in Kashiwazaki City. In the results of the past games, a lot of descriptions, such as “×× of two-base hit, ×× of three-base hits” are included, and the morphemes of “two-base hit” and “three-base hit” indicate significantly high discriminating values.

In the latter case, a high discriminating value may be applied to a term being less associated with this art of the corpus increasing in time series, so that the possibility of sometimes causing the user to erroneously understand the news cannot be denied.

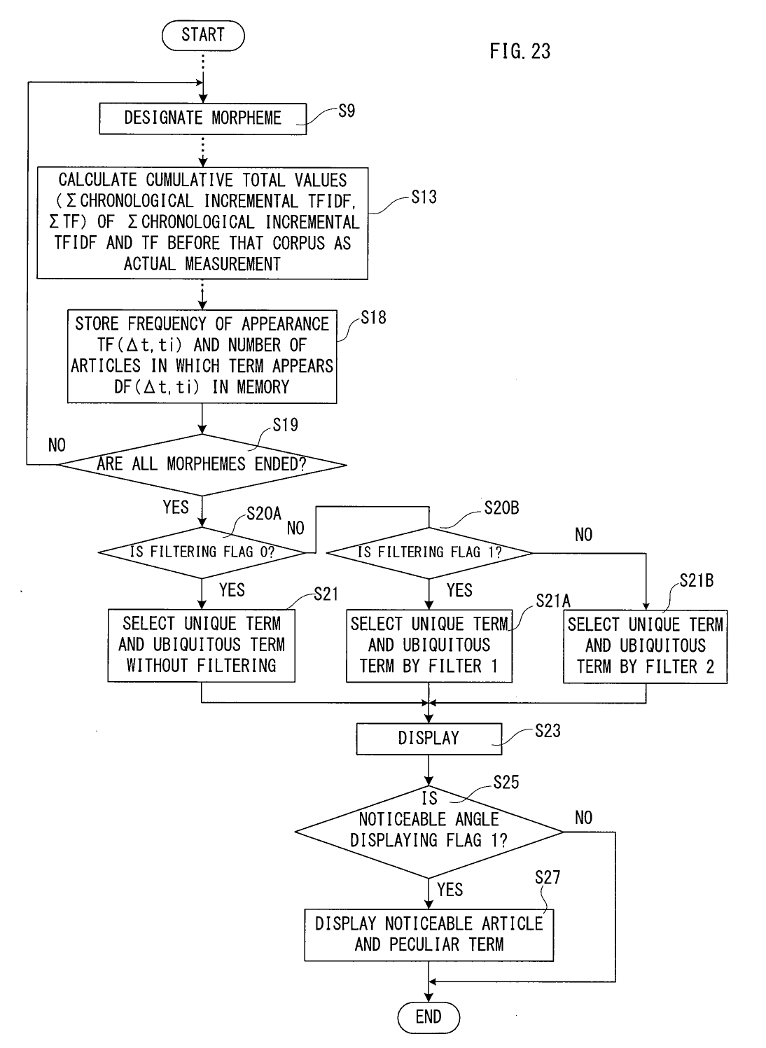

Here, in another embodiment of this invention shown in FIG. 23 onward, a method of removing a morpheme indicating a extremely high discriminating value by performing a filtering 1 for removing a term (morpheme) about which the number of documents the morpheme appears is one in Δt (1), and/or a method of removing a morpheme indicating a extremely high discriminating value by performing a filtering 2 of removing a morpheme with a substantially high frequency of appearance from the relationship between the number of documents the morpheme appears and a frequency of appearance of a term (morpheme) (2) are proposed. Here, whether or not these methods are adopted is relied on the user as an option.

In addition, the present invention is for performing an analysis of a unique term (keyword) by using a morpheme as a unit and visualizing it. A defect of the analysis by taking a morpheme as a unit is that the information on the context that each morpheme (unique term) essentially has is lost, and this makes it difficult to understand and interpret what the term with a high peculiarity represents. Thus, in this embodiment below, a technique of complementing the information on the context by displaying an article to be noted, and supporting the understanding and interpretation of the analysis result is proposed.

FIG. 23 is a flowchart showing an operation of another embodiment of this invention. This embodiment is an embodiment adopting the above-described filtering and displaying a noticeable article as an option.

In FIG. 23, steps before the step S17 are the same as the step S1-S17 previously shown in FIG. 3 embodiment, and therefore, the duplicated explanation is omitted here.

Here, in this embodiment, before starting the operation in FIG. 23, a user selectively sets in advance through a GUI (not shown) displayed by the computer 14 on the monitor 15B whether or not a filtering is adopted as an option, which filtering is adopted, the filtering 1 or the filtering 2 if adopted, and moreover, whether or not a display of noticeable articles are adopted as an option, by means of the operating means 15A shown in FIG. 1. Then, the user setting is stored in a memory (not shown) within the computer 14 as a flag. If the filtering option is not selected, a filtering flag is stored as “0”, if the filtering 1 is selected, the filtering flag is stored as “1”, and if the filtering 2 is selected, the filtering flag is stored as “2”. Then, when the noticeable article displaying option is selected, a noticeable article displaying flag is set to “1”.

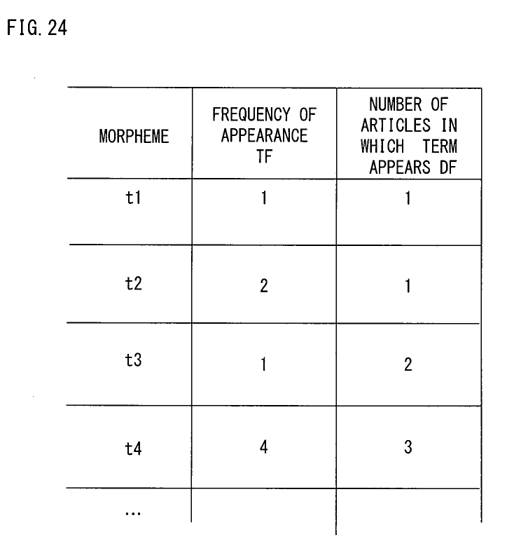

Next, after execution of the processing until the step S17, the computer 14 stores, in the memory of the computer 14, the frequency of appearance TF (Δt, ti) of the term (morpheme) during the time period Δt and the number of documents (articles) in which the term (morpheme) appears DF (Δt, ti) within the time period Δt in the format in FIG. 24 in a step S18. However, these frequency of appearance TF (Δt, ti) and the number of documents in which the term appears DF (Δt, ti) are evaluated in the step S13 previously described, and in this step S18, these numerical values are stored as shown in FIG. 24.

Here, these frequency of appearance TF (Δt, ti) and the number of documents in which the term appears DF (Δt, ti) are not used if the user does not select the filtering as an option. In this case, “YES” is determined in a step S20A, and unique terms and ubiquitous terms (general term) are selected in a step S21 in a manner the same as the step S21 in FIG. 3, and the process proceeds to a step S23. In the step S23, a graph display as shown in FIG. 15-FIG. 21 is performed on the monitor 15B.

When the filtering option is set, “NO” is determined in step S20A, and therefore, in a succeeding step S20B, the computer 14 determines whether or not the filtering flag is “1” with reference to a flag area of the memory (not shown). The fact that “YES” is determined in the step S20B means that the filtering 1 is selected as an option, and the fact that “NO” is determined means that the filtering 2 is selected as an option.

If the filtering 1 is selected as an option, the computer 14 selects unique terms and ubiquitous terms by the filter 1 in a next step S21A.

More specifically, with reference to the data of the number of documents in which the term appears DF (Δt, ti) in each time period Δt stored in the step S18 in the memory in FIG. 24, after the morpheme ti when the DF (Δt, ti)=1 is removed, unique terms and ubiquitous terms are selected in the manner the same as that in the step S21.

If the filtering 2 is selected as an option, the computer 14 selects unique terms and ubiquitous terms by the filter 2 in a next step S21B.

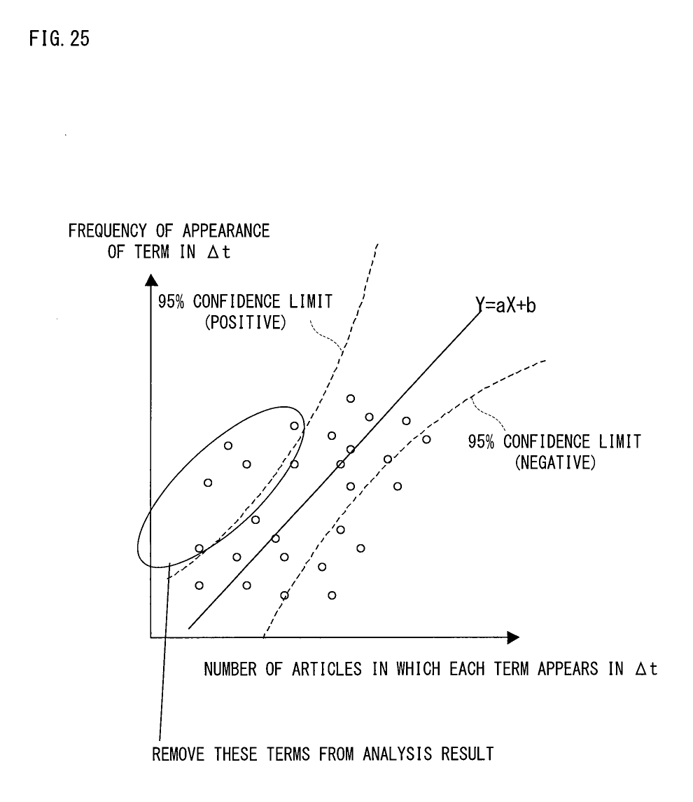

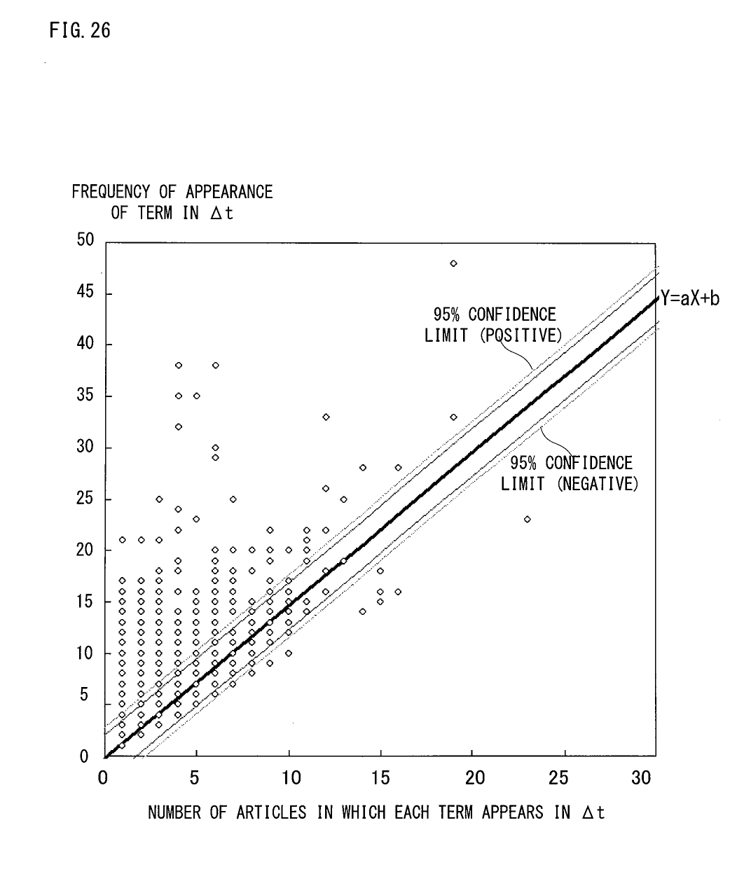

More specifically, the number of documents in which the term appears DF (Δt, ti) and the frequency of appearance TF (Δt, ti) which are stored in the step S18 are read, and a regression curve (FIG. 25, FIG. 26) of Y=aX+b is evaluated by regarding in each time point, an explanatory variable X as the number of documents in which the term appears DF (Δt, ti) in each time Δt, and regarding a response variable Y as the number of documents in which the term appears DF (Δt, ti) in the time Δt. Δt the same time, a 95% confidence limit of the regression curve is evaluated (see FIG. 25, FIG. 26). Then, the number of documents in which the term appears DF (Δt, ti) at this point Δt and the data of the frequency of appearance TF(Δt, ti) at this point Δt which are read from the memory are compared with the 95% confidence limit, and if the frequency of appearance TF (Δt, ti) at this point Δt is above a positive 95% confidence limit, the term (morpheme) ti is removed, and then, unique terms and ubiquitous terms are selected similarly to the step S21.

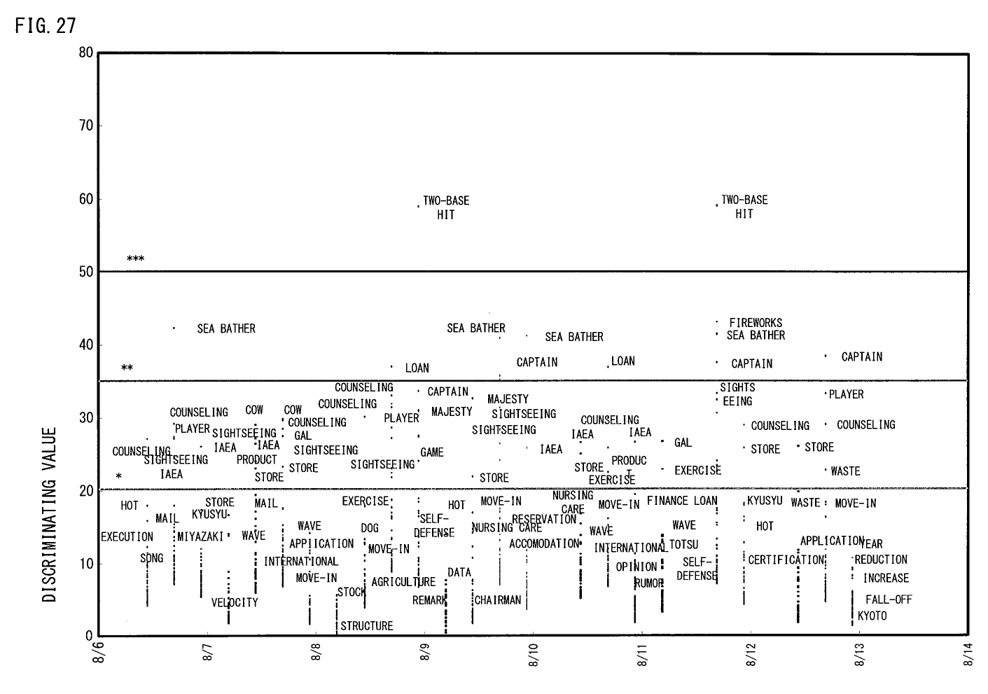

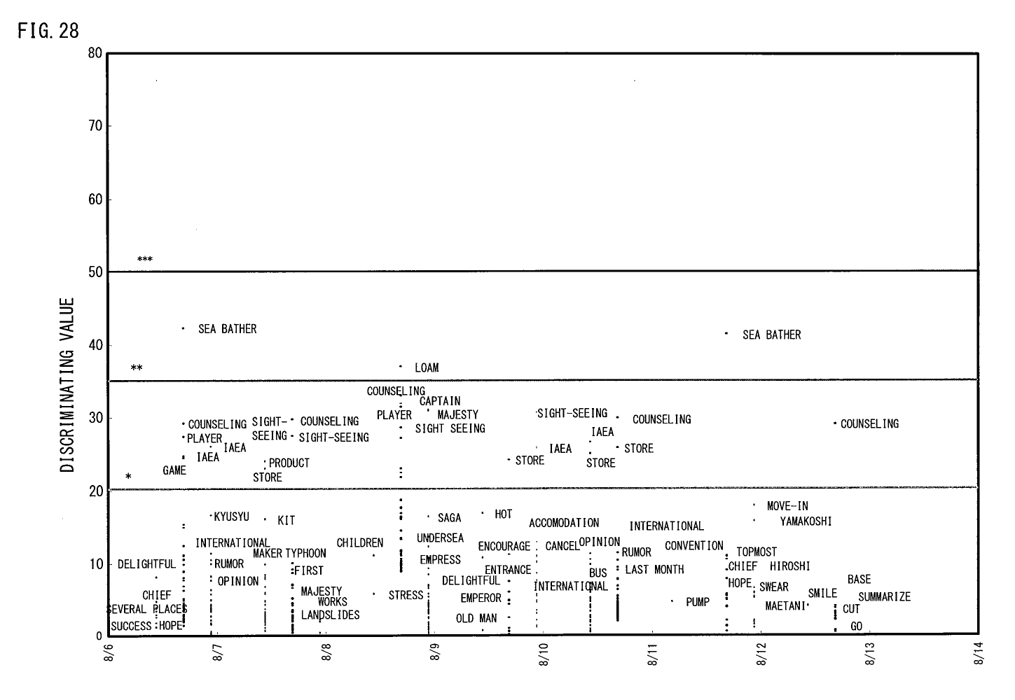

Here, FIG. 25 and FIG. 26 are graphs of the same meaning, but FIG. 25 is a general representation, and FIG. 26 shows a concrete example appearing by the experiments by the inventor, et al. If a morpheme is above or below the 95% confidence limit (if it is above the 95% confidence limit for the positive case) in both of the positive and negative cases, the morpheme is excluded. In a case that a filtering option is not selected in this embodiment, a graph display shown in FIG. 27 is performed in a step S23 while if the filtering 1 is selected, a graph display shown in the step S23 is performed as shown in FIG. 28. If both of the cases are compared, a morpheme “two-base hit” appearing in only one article is displayed as a unique term having a high discriminating value in the former case, but the morpheme “two-base hit” is removed by the filtering processing and not displayed in the latter case. In that sense, a problem of displaying a unique term irrelevant to the theme of the analysis is canceled, but as can be understood from the comparison between FIG. 27 and FIG. 28, a point that other morphemes tend to be removed in the filtering 1 has to be notified.

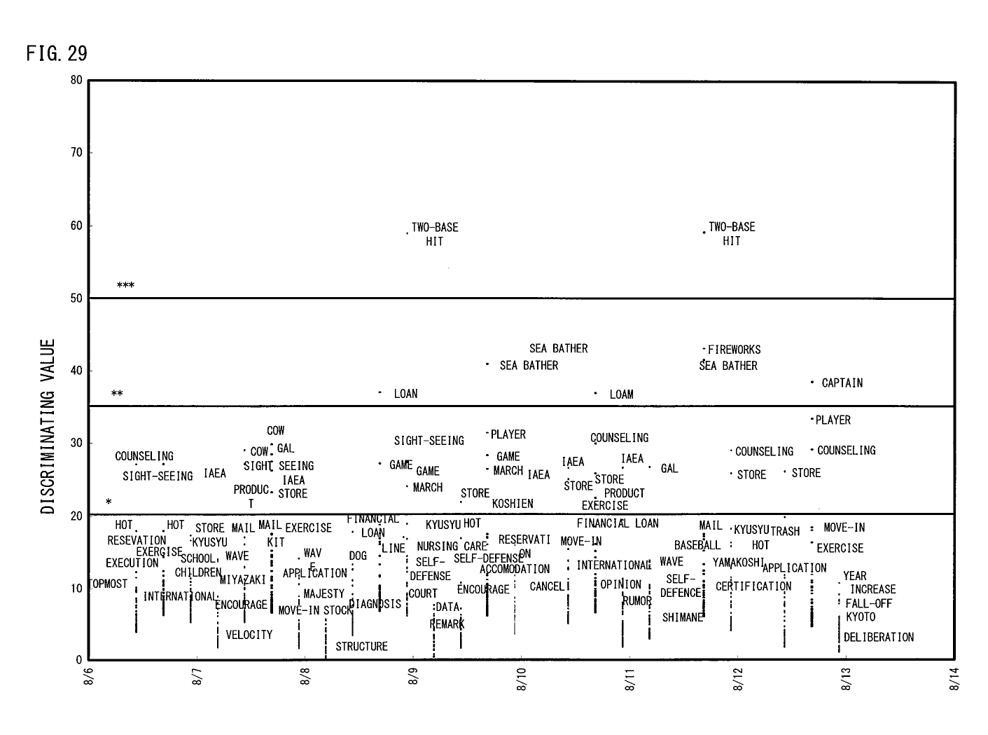

The graph display in the step S23 in a case that the filtering 2 is selected is as shown in FIG. 29. In a case that the option of the filtering 2 is executed, as can be understood from a comparison between FIG. 27 and FIG. 28, the irrelevant term “two-base hit” remains, but the other unnecessary words are eliminated, allowing an easily viewable graph display more or less.

After the analysis result is visually displayed in the step S23, the computer 14 determines whether or not the noticeable article displaying flag is “1” with reference to the memory in a step S25. If “NO”, the process is directly ended, but if “YES”, a displaying step of the noticeable articles on the monitor 15B is executed in a step S27.

More specifically, when a residual value is evaluated in the preceding step S17, a list of the discriminating value DVti of the term ti is produced at each time point, and therefore, a sum of the discriminating values (RV=ΣDVti) is evaluated for each document as to the unique term (the top ten words with a high discriminating value) included in the document in the time Δt. Then, the top three documents being high in the sum RV of the discriminating value are selected as “noticeable articles”. With respect to the selected “noticeable articles”, unique terms (top 10) included in at least the headline and the content are displayed as shown in the Table 2.

Which document the morpheme ti listed up in the aforementioned discriminating value list is included in can be specified by referring to the text data table 20 shown in FIG. 2, for example. That is, in this step S27, by reading a document with a document number (ID) including a morpheme being high in the sum of the discriminating value RV from the data table 20, displaying the noticeable article as in the Table 2 is executed.

TABLE 2
Display example of the noticeable article

```
1st place:
RV = 19.0, active, earthquake resistant
    “Japan Atomic Industrial Association chairman said “the safety of nuclear power
plants is retained”
    “Nippon-Keidanren honorary chairman and Japan Atomic Industrial Association
chairman, Mr. Kei Imai (honorary chairman of Nippon Steel Corporation) had an
interview of 17th in Matsue City, ...
  “Check the fire extinguishing system in the Shimane nuclear plant for the Niigata
Chuetsu Oki earthquake”
    “About the problem of starting fire from the electrical transformer at the Tokyo
Electric Power Co.'s Kashiwazaki-Kariwa nuclear power plant caused by Niigata
Chuetsu Oki earthquake, ....
3rd place:
RV = 12.7, telephone
    “<Chuetsu Oki earthquake> At night of the second day, 9000 escaped people”
    “Niigata Chuetsu Oki earthquake, which enters the second night on 17th, caused
8995 victims of the disaster to live in evacuation centers, like 111 public halls in seven
municipalities, such as Kashiwazaki Citiy....
```

In the table 2, with respect to the two articles including two words “active” and “earthquake resistant” each having the sum of the discriminating values RV “19.0” and the one article including one term “telephone” having the sum of the discriminating values RV “12.7”, at least the headline, preferably including the content, is displayed. This makes it possible to complement the information of the context of the morphemes lost by the analysis, and thus avoid difficulty of understanding and interpreting what the term showing a high peculiarity represents.

Here, in the above-described embodiment, with respect to the top three morphemes being high in the sum of the discriminating values RV, the “articles” including them, that is, the unit documents are displayed, but the number of morphemes about which the article is displayed is arbitrary. With respect to only the top morpheme, the article (headline) including this may be displayed, and with respect to the top ten morphemes, the articles and the headlines may be displayed.

Additionally, in order to visually output the selected unique terms and general words, these are displayed on the monitor in this embodiment, but in place of the display or in addition to the display, a printout by a printer, for example, may be possible.

In FIG. 15-FIG. 21 and FIG. 27-FIG. 29, it should be noted that some unique terms (keywords) to be written are omitted. The reason is that a margin is retained as much as possible within the drawings, and therefore, in a narrow place, more words to be written are omitted.

Although the present invention has been described and illustrated in detail, it is clearly understood that the same is by way of illustration and example only and is not to be taken by way of limitation, the spirit and scope of the present invention being limited only by the terms of the appended claims.

1. A document analyzing apparatus for analyzing a linguistic material which increases in time series, comprising:
a text corpus producer for producing a body of linguistic textual material (text corpus) including text data of unit documents having a chronological order in which unit documents later in said chronological order are larger in number than unit documents earlier in the chronological order;
a morpheme analyzer for adding parts-of-speech information to morphemes making up the text data included in said corpus text;
an unnecessary morpheme remover for removing an unnecessary morpheme from said text data on the basis of said parts-of-speech information;
a calculator for calculating, with respect to the morphemes which are not removed by said unnecessary morpheme remover, a chronological incremental term frequency inversed document frequency (TFIDF) for each morpheme to obtain an actual measurement of the chronological incremental TFIDF; and
a residual analyzer for evaluating a residual value for each morpheme by performing a residual analysis between said actual measurement calculated by said calculator and an estimate of the value of a cumulative total value of said chronological incremental TFIDF estimated in a previous text corpus.

2. A document analyzing apparatus according to claim 1, further comprising:
a regression curve producer for producing a regression curve in each text corpus between a cumulative total value of a chronological incremental TFIDF and a cumulative total value of a term frequency (TF) which are evaluated from a text corpus at an arbitrary time point, wherein
said residual analyzer performs a residual analysis between a regression curve produced by said regression curve producer in a previous text corpus and said actual measurement of said chronological incremental TFIDF of each morpheme calculated by said calculator in a current text corpus.

3. A document analyzing apparatus according to claim 2, further comprising a unique term selector for selecting a morpheme for which a positive residual value can be obtained as a result of the residual analysis by said residual analyzer as a unique term in the text corpus.

4. A document analyzing apparatus according to claim 3, wherein said unique term selector includes a filterer for performing filtering processing.

5. A document analyzing apparatus according to claim 4, further comprising a unique term output unit for visually outputting the unique term selected by said unique term selector.

6. A document analyzing apparatus according to claim 5, further comprising a ubiquitous term selector for selecting the morpheme for which a negative residual value can be obtained as a result of the residual analysis by said residual analyzer as a ubiquitous term of the corpus.

7. A document analyzing apparatus according to claim 6, further comprising a ubiquitous term output unit for visually outputting the ubiquitous term selected by said ubiquitous term selector.

8. A document analyzing apparatus according to claim 5, further comprising a document output unit for visually outputting, with respect to at least one of the unique terms output by said unique term output unit, a unit document including said unique term.

9. A document analyzing program for analyzing a linguistic material which increases in time series causes a computer to function as:
a text corpus producing module for producing a body of linguistic textual material (text corpus) including text data of unit documents having a chronological order in which unit documents later in said chronological order are larger in number than unit documents earlier in the chronological order;
a morpheme analyzing module for adding parts-of-speech information to morphemes making up the text data included in said corpus text;
an unnecessary morpheme removing module for removing an unnecessary morpheme from said text data on the basis of said parts-of-speech information;
a calculating module for calculating, with respect to the morphemes which are not removed by said unnecessary morpheme removing means, a chronological incremental term frequency inversed document frequency (TFIDF) for each morpheme to obtain an actual measurement of the chronological incremental TFIDF; and
a residual analyzing module for evaluating a residual value for each morpheme by performing a residual analysis between said actual measurement calculated by said calculator and an estimate value of the cumulative total value of said chronological incremental TFIDF estimated in a previous text corpus.

10. A document analyzing method for analyzing a linguistic material which increases in time series, including steps of:
producing a body of linguistic textual material (text corpus) including text data of unit documents having a chronological order in which unit documents later in said chronological order are larger in number than unit documents earlier in the chronological order, and
analyzing a morpheme and adding parts-of-speech information to morphemes making up of the text data included in said corpus text;
removing unnecessary morpheme from said text data on the basis of said parts-of-speech information;
calculating, with respect to the morphemes which are not removed by said unnecessary morpheme removing step, a chronological incremental term frequency inversed document frequency (TFIDF) for each morpheme to obtain an actual measurement of the chronological incremental TFIDF; and
evaluating a residual value for each morpheme by performing a residual analysis between said actual measurement calculated by said calculating step and an estimate value of the cumulative total value of said chronological incremental TFIDF estimated in a previous text corpus.
